(19) United States
(12) Patent Application Publication
(10) Pub. No.: US 2026/0079248 A1
(43) Pub. Date: Mar. 19, 2026

(54) RADAR APPARATUS, SYSTEM, AND METHOD

(71) Applicant: MobilEye Vision Technologies Ltd., Jerusalem (IL)

(72) Inventors: Ofer Gueta, Ganei-Tikva (IL); Nati Dinur, Atlit (IL); Moshe Teplitsky, Tel-Aviv (IL); Ophir Shabtay, Tsofit (IL)

(73) Assignee: MobilEye Vision Technologies Ltd., Jerusalem (IL)

(21) Appl. No.: 19/287,377

(22) Filed: Jul. 31, 2025

Related U.S. Application Data
(60) Provisional application No. 63/696,804, filed on Sep. 19, 2024.
(60) Provisional application No. 63/773,997, filed on Mar. 18, 2025.

(51) Int. Cl. G01S 13/32; G01S 7/282; G01S 7/292; G01S 13/34; G01S 13/88

(52) U.S. Cl. CPC G01S 13/325; G01S 7/282; G01S 7/2923; G01S 13/34; G01S 13/881

(57) ABSTRACT

For example, an apparatus may include a processor, which may be configured to identify a particular Transmit (Tx) configuration selected from a plurality of Tx configurations. For example, the plurality of Tx configurations may have a plurality of different Pulse Repetition Intervals (PRIs), respectively. For example, the particular Tx configuration may have a particular PRI from the plurality of different PRIs. For example, the processor may be configured to generate Tx configuration information to configure transmission of a plurality of radar Tx pulses from a radar device according to the particular PRI of the particular Tx configuration. For example, the apparatus may include an output to provide the Tx configuration information.

### CROSS-REFERENCE

This application claims the benefit of and priority from U.S. Provisional Patent Application No. 63/696,804, entitled “RADAR APPARATUS, SYSTEM, AND METHOD”, filed Sep. 19, 2024, and from U.S. Provisional Patent Application No. 63/773,997, entitled “RADAR APPARATUS, SYSTEM, AND METHOD”, filed Mar. 18, 2025, the entire disclosures of which are incorporated herein by reference.

### BACKGROUND

Various types of devices and systems, for example, autonomous and/or robotic devices, e.g., autonomous vehicles and robots, may be configured to perceive and navigate through their environment using sensor data of one or more sensor types.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a vehicle implementing a radar, in accordance with some demonstrative aspects.

FIG. 2 is a schematic block diagram illustration of a robot implementing a radar, in accordance with some demonstrative aspects.

FIG. 3 is a schematic block diagram illustration of a radar apparatus, in accordance with some demonstrative aspects.

FIG. 4 is a schematic block diagram illustration of a Frequency-Modulated Continuous Wave (FMCW) radar apparatus, in accordance with some demonstrative aspects.

FIG. 5 is a schematic illustration of an extraction scheme, which may be implemented to extract range and speed (Doppler) estimations from digital reception radar data values, in accordance with some demonstrative aspects.

FIG. 6 is a schematic illustration of an angle-determination scheme, which may be implemented to determine Angle of Arrival (AoA) information based on an incoming radio signal received by a receive antenna array, in accordance with some demonstrative aspects.

FIG. 7 is a schematic illustration of a Multiple-Input-Multiple-Output (MIMO) radar antenna scheme, which may be implemented based on a combination of Transmit (Tx) and Receive (Rx) antennas, in accordance with some demonstrative aspects.

FIG. 8 is a schematic block diagram illustration of elements of a radar device including a radar frontend and a radar processor, in accordance with some demonstrative aspects.

FIG. 9 is a schematic illustration of a radar system including a plurality of radar devices implemented in a vehicle, in accordance with some demonstrative aspects.

FIG. 10 is a schematic illustration of a system, in accordance with some demonstrative aspects.

FIG. 11 is a schematic illustration of a radar frame, in accordance with some demonstrative aspects.

FIG. 12 is a schematic illustration of a first radar frame having a first Pulse Repetition Interval (PRI), and a second radar frame having a second PRI, in accordance with some demonstrative aspects.

FIG. 13 is a schematic illustration of a first slow time-fast time diagram, and a second slow time-fast time diagram, in accordance with some demonstrative aspects.

FIG. 14 is a schematic illustration of a chirp generator, in accordance with some demonstrative aspects.

FIG. 15 is a schematic illustration of a PRI configuration mechanism, in accordance with some demonstrative aspects.

FIG. 16 is a schematic illustration of simulation results to illustrate a range smearing effect, in accordance with some demonstrative aspects.

FIG. 17 is a schematic illustration of simulation results to illustrate a range smearing effect, in accordance with some demonstrative aspects.

FIG. 18 is a schematic flow chart illustration of a method of configuring transmission of a plurality of radar Tx pulses from a radar device, in accordance with some demonstrative aspects.

FIG. 19 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

The words “exemplary” and “demonstrative” are used herein to mean “serving as an example, instance, demonstration, or illustration”. Any aspect, aspect, or design described herein as “exemplary” or “demonstrative” is not necessarily to be construed as preferred or advantageous over other aspects, aspects, or designs.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

The phrases “at least one” and “one or more” may be understood to include a numerical quantity greater than or equal to one, e.g., one, two, three, four, [ . . . ], etc. The phrase “at least one of” with regard to a group of elements may be used herein to mean at least one element from the group consisting of the elements. For example, the phrase “at least one of” with regard to a group of elements may be used herein to mean one of the listed elements, a plurality of one of the listed elements, a plurality of individual listed elements, or a plurality of a multiple of individual listed elements.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and/or may represent any information as understood in the art.

The terms “processor” or “controller” may be understood to include any kind of technological entity that allows handling of any suitable type of data and/or information. The data and/or information may be handled according to one or more specific functions executed by the processor or controller. Further, a processor or a controller may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), and the like, or any combination thereof. Any other kind of implementation of the respective functions, which will be described below in further detail, may also be understood as a processor, controller, or logic circuit. It is understood that any two (or more) processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

The term “memory” is understood as a computer-readable medium (e.g., a non-transitory computer-readable medium) in which data or information can be stored for retrieval. References to “memory” may thus be understood as referring to volatile or non-volatile memory, including random access memory (RAM), read-only memory (ROM), flash memory, solid-state storage, magnetic tape, hard disk drive, optical drive, among others, or any combination thereof. Registers, shift registers, processor registers, data buffers, among others, are also embraced herein by the term memory. The term “software” may be used to refer to any type of executable instruction and/or logic, including firmware.

A “vehicle” may be understood to include any type of driven object. By way of example, a vehicle may be a driven object with a combustion engine, an electric engine, a reaction engine, an electrically driven object, a hybrid driven object, or a combination thereof. A vehicle may be, or may include, an automobile, a bus, a mini bus, a van, a truck, a mobile home, a vehicle trailer, a motorcycle, a bicycle, a tricycle, a train locomotive, a train wagon, a moving robot, a personal transporter, a boat, a ship, a submersible, a submarine, a drone, an aircraft, a rocket, among others.

A “ground vehicle” may be understood to include any type of vehicle, which is configured to traverse the ground, e.g., on a street, on a road, on a track, on one or more rails, off-road, or the like.

An “autonomous vehicle” may describe a vehicle capable of implementing at least one navigational change without driver input. A navigational change may describe or include a change in one or more of steering, braking, acceleration/deceleration, or any other operation relating to movement, of the vehicle. A vehicle may be described as autonomous even in case the vehicle is not fully autonomous, for example, fully operational with driver or without driver input. Autonomous vehicles may include those vehicles that can operate under driver control during certain time periods, and without driver control during other time periods. Additionally or alternatively, autonomous vehicles may include vehicles that control only some aspects of vehicle navigation, such as steering, e.g., to maintain a vehicle course between vehicle lane constraints, or some steering operations under certain circumstances, e.g., not under all circumstances, but may leave other aspects of vehicle navigation to the driver, e.g., braking or braking under certain circumstances. Additionally or alternatively, autonomous vehicles may include vehicles that share the control of one or more aspects of vehicle navigation under certain circumstances, e.g., hands-on, such as responsive to a driver input; and/or vehicles that control one or more aspects of vehicle navigation under certain circumstances, e.g., hands-off, such as independent of driver input. Additionally or alternatively, autonomous vehicles may include vehicles that control one or more aspects of vehicle navigation under certain circumstances, such as under certain environmental conditions, e.g., spatial areas, roadway conditions, or the like. In some aspects, autonomous vehicles may handle some or all aspects of braking, speed control, velocity control, steering, and/or any other additional operations, of the vehicle. An autonomous vehicle may include those vehicles that can operate without a driver. The level of autonomy of a vehicle may be described or determined by the Society of Automotive Engineers (SAE) level of the vehicle, e.g., as defined by the SAE, for example in SAE J3016 2018: Taxonomy and definitions for terms related to driving automation systems for on road motor vehicles, or by other relevant professional organizations. The SAE level may have a value ranging from a minimum level, e.g., level 0 (illustratively, substantially no driving automation), to a maximum level, e.g., level 5 (illustratively, full driving automation).

An “assisted vehicle” may describe a vehicle capable of informing a driver or occupant of the vehicle of sensed data or information derived therefrom.

The phrase “vehicle operation data” may be understood to describe any type of feature related to the operation of a vehicle. By way of example, “vehicle operation data” may describe the status of the vehicle, such as, the type of tires of the vehicle, the type of vehicle, and/or the age of the manufacturing of the vehicle. More generally, “vehicle operation data” may describe or include static features or static vehicle operation data (illustratively, features or data not changing over time). As another example, additionally or alternatively, “vehicle operation data” may describe or include features changing during the operation of the vehicle, for example, environmental conditions, such as weather conditions or road conditions during the operation of the vehicle, fuel levels, fluid levels, operational parameters of the driving source of the vehicle, or the like. More generally, “vehicle operation data” may describe or include varying features or varying vehicle operation data (illustratively, time varying features or data).

Some aspects may be used in conjunction with various devices and systems, for example, a radar sensor, a radar device, a radar system, a vehicle, a vehicular system, an autonomous vehicular system, a vehicular communication system, a vehicular device, an airborne platform, a waterborne platform, road infrastructure, sports-capture infrastructure, city monitoring infrastructure, static infrastructure platforms, indoor platforms, moving platforms, robot platforms, industrial platforms, a sensor device, a User Equipment (UE), a Mobile Device (MD), a wireless station (STA), a sensor device, a non-vehicular device, a mobile or portable device, and the like.

Some aspects may be used in conjunction with Radio Frequency (RF) systems, radar systems, vehicular radar systems, autonomous systems, robotic systems, detection systems, or the like.

Some demonstrative aspects may be used in conjunction with an RF frequency in a frequency band having a starting frequency above 10 Gigahertz (GHz), for example, a frequency band having a starting frequency between 10 GHz and 120 GHz. For example, some demonstrative aspects may be used in conjunction with an RF frequency having a starting frequency above 30 GHz, for example, above 45 GHz, e.g., above 60 GHz. For example, some demonstrative aspects may be used in conjunction with an automotive radar frequency band, e.g., a frequency band between 76 GHz and 81 GHz. However, other aspects may be implemented utilizing any other suitable frequency bands, for example, a frequency band above 140 GHz, a frequency band of 300 GHz, a sub Terahertz (THz) band, a THz band, an Infra-Red (IR) band, and/or any other frequency band.

As used herein, the term “circuitry” may refer to, be part of, or include, an Application Specific Integrated Circuit (ASIC), an integrated circuit, an electronic circuit, a processor (shared, dedicated, or group), and/or memory (shared, dedicated, or group), that execute one or more software or firmware programs, a combinational logic circuit, and/or other suitable hardware components that provide the described functionality In some aspects, some functions associated with the circuitry may be implemented by one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g., radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and/or the like. Logic may be executed by one or more processors using memory, e.g., registers, buffers, stacks, and the like, coupled to the one or more processors, e.g., as necessary to execute the logic.

The term “communicating” as used herein with respect to a signal includes transmitting the signal and/or receiving the signal. For example, an apparatus, which is capable of communicating a signal, may include a transmitter to transmit the signal, and/or a receiver to receive the signal. The verb communicating may be used to refer to the action of transmitting or the action of receiving. In one example, the phrase “communicating a signal” may refer to the action of transmitting the signal by a transmitter, and may not necessarily include the action of receiving the signal by a receiver. In another example, the phrase “communicating a signal” may refer to the action of receiving the signal by a receiver, and may not necessarily include the action of transmitting the signal by a transmitter.

The term “antenna”, as used herein, may include any suitable configuration, structure, and/or arrangement of one or more antenna elements, components, units, assemblies, and/or arrays. In some aspects, the antenna may implement transmit and receive functionalities using separate transmit and receive antenna elements. In some aspects, the antenna may implement transmit and receive functionalities using common and/or integrated transmit/receive elements. The antenna may include, for example, a phased array antenna, a MIMO (Multiple-Input Multiple-Output) array antenna, a single element antenna, a set of switched beam antennas, and/or the like. In one example, an antenna may be implemented as a separate element or an integrated element, for example, as an on-module antenna, an on-chip antenna, or according to any other antenna architecture.

Some demonstrative aspects are described herein with respect to RF radar signals. However, other aspects may be implemented with respect to, or in conjunction with, any other radar signals, wireless signals, IR signals, acoustic signals, optical signals, wireless communication signals, communication scheme, network, standard, and/or protocol. For example, some demonstrative aspects may be implemented with respect to systems, e.g., Light Detection Ranging (LiDAR) systems, and/or sonar systems, utilizing light and/or acoustic signals.

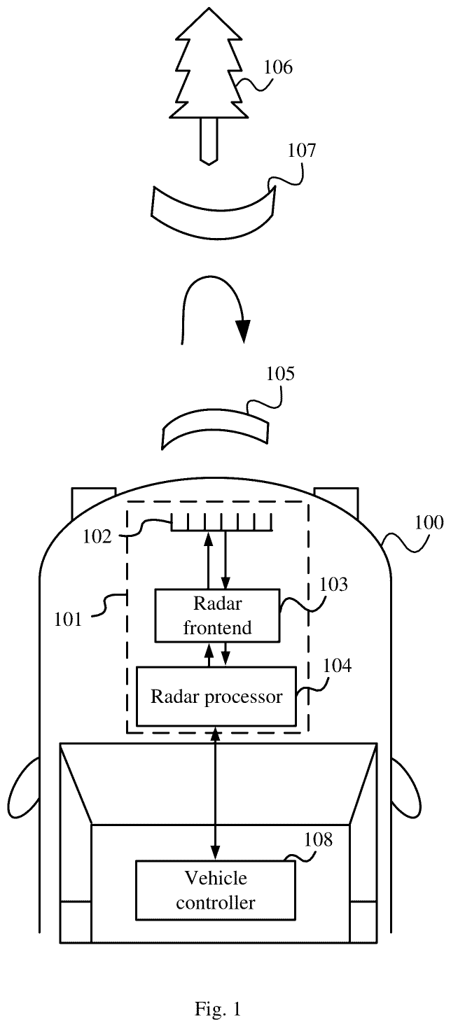

Reference is now made to FIG. 1, which schematically illustrates a block diagram of a vehicle 100 implementing a radar, in accordance with some demonstrative aspects.

In some demonstrative aspects, vehicle 100 may include a car, a truck, a motorcycle, a bus, a train, an airborne vehicle, a waterborne vehicle, a cart, a golf cart, an electric cart, a road agent, or any other vehicle.

In some demonstrative aspects, vehicle 100 may include a radar device 101, e.g., as described below. For example, radar device 101 may include a radar detecting device, a radar sensing device, a radar sensor, or the like, e.g., as described below.

In some demonstrative aspects, radar device 101 may be implemented as part of a vehicular system, for example, a system to be implemented and/or mounted in vehicle 100.

In one example, radar device 101 may be implemented as part of an autonomous vehicle system, an automated driving system, an assisted vehicle system, a driver assistance and/or support system, and/or the like.

For example, radar device 101 may be installed in vehicle 100 for detection of nearby objects, e.g., for autonomous driving.

In some demonstrative aspects, radar device 101 may be configured to detect targets in a vicinity of vehicle 100, e.g., in a far vicinity and/or a near vicinity, for example, using RF and analog chains, capacitor structures, large spiral transformers and/or any other electronic or electrical elements, e.g., as described below.

In one example, radar device 101 may be mounted onto, placed, e.g., directly, onto, or attached to, vehicle 100.

In some demonstrative aspects, vehicle 100 may include a plurality of radar aspects, vehicle 100 may include a single radar device 101.

In some demonstrative aspects, vehicle 100 may include a plurality of radar devices 101, which may be configured to cover a field of view of 360 degrees around vehicle 100.

In other aspects, vehicle 100 may include any other suitable count, arrangement, and/or configuration of radar devices and/or units, which may be suitable to cover any other field of view, e.g., a field of view of less than 360 degrees.

In some demonstrative aspects, radar device 101 may be implemented as a component in a suite of sensors used for driver assistance and/or autonomous vehicles, for example, due to the ability of radar to operate in nearly all-weather conditions.

In some demonstrative aspects, radar device 101 may be configured to support autonomous vehicle usage, e.g., as described below.

In one example, radar device 101 may determine a class, a location, an orientation, a velocity, an intention, a perceptional understanding of the environment, and/or any other information corresponding to an object in the environment.

In another example, radar device 101 may be configured to determine one or more parameters and/or information for one or more operations and/or tasks, e.g., path planning, and/or any other tasks.

In some demonstrative aspects, radar device 101 may be configured to map a scene by measuring targets' echoes (reflectivity) and discriminating them, for example, mainly in range, velocity, azimuth and/or elevation, e.g., as described below.

In some demonstrative aspects, radar device 101 may be configured to detect, and/or sense, one or more objects, which are located in a vicinity, e.g., a far vicinity and/or a near vicinity, of the vehicle 100, and to provide one or more parameters, attributes, and/or information with respect to the objects.

In some demonstrative aspects, the objects may include road users, such as other vehicles, pedestrians; road objects and markings, such as traffic signs, traffic lights, lane markings, road markings, road elements, e.g., a pavement-road meeting, a road edge, a road profile, road roughness (or smoothness); general objects, such as a hazard, e.g., a tire, a box, a crack in the road surface; and/or the like.

In some demonstrative aspects, the one or more parameters, attributes and/or information with respect to the object may include a range of the objects from the vehicle 100, an angle of the object with respect to the vehicle 100, a location of the object with respect to the vehicle 100, a relative speed of the object with respect to vehicle 100, and/or the like.

In some demonstrative aspects, radar device 101 may include a Multiple Input Multiple Output (MIMO) radar device 101, e.g., as described below.

In one example, the MIMO radar device may be configured to utilize “spatial filtering” processing, for example, beamforming and/or any other mechanism, for one or both of Transmit (Tx) signals and/or Receive (Rx) signals.

Some demonstrative aspects are described below with respect to a radar device, e.g., radar device 101, implemented as a MIMO radar. However, in other aspects, radar device 101 may be implemented as any other type of radar utilizing a plurality of antenna elements, e.g., a Single Input Multiple Output (SIMO) radar or a Multiple Input Single output (MISO) radar.

Some demonstrative aspects may be implemented with respect to a radar device, e.g., radar device 101, implemented as a MIMO radar, e.g., as described below. However, in other aspects, radar device 101 may be implemented as any other type of radar, for example, an Electronic Beam Steering radar, a Synthetic Aperture Radar (SAR), adaptive and/or cognitive radars that change their transmission according to the environment and/or ego state, a reflect array radar, or the like.

In some demonstrative aspects, radar device 101 may include an antenna arrangement 102, a radar frontend 103 configured to communicate radar signals via the antenna arrangement 102, and a radar processor 104 configured to generate radar information based on the radar signals, e.g., as described below.

In some demonstrative aspects, radar processor 104 may be configured to process radar information of radar device 101 and/or to control one or more operations of radar device 101, e.g., as described below.

In some demonstrative aspects, radar processor 104 may include, or may be implemented, partially or entirely, by circuitry and/or logic, e.g., one or more processors including circuitry and/or logic, memory circuitry and/or logic. Additionally or alternatively, one or more functionalities of radar processor 104 may be implemented by logic, which may be executed by a machine and/or one or more processors, e.g., as described below.

In one example, radar processor 104 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In other aspects, radar processor 104 may be implemented by one or more additional or alternative elements of vehicle 100.

In some demonstrative aspects, radar frontend 103 may include, for example, one or more (radar) transmitters, and one or more (radar) receivers, e.g., as described below.

In some demonstrative aspects, antenna arrangement 102 may include a plurality of antennas to communicate the radar signals. For example, antenna arrangement 102 may include multiple transmit antennas in the form of a transmit antenna array, and multiple receive antennas in the form of a receive antenna array. In another example, antenna arrangement 102 may include one or more antennas used both as transmit and receive antennas. In the latter case, the radar frontend 103, for example, may include a duplexer or a circulator, e.g., a circuit to separate transmitted signals from received signals.

In some demonstrative aspects, as shown in FIG. 1, the radar frontend 103 and the antenna arrangement 102 may be controlled, e.g., by radar processor 104, to transmit a radio transmit signal 105.

In some demonstrative aspects, as shown in FIG. 1, the radio transmit signal 105 may be reflected by an object 106, resulting in an echo 107.

In some demonstrative aspects, the radar device 101 may receive the echo 107, e.g., via antenna arrangement 102 and radar frontend 103, and radar processor 104 may generate radar information, for example, by calculating information about position, radial velocity (Doppler), and/or direction of the object 106, e.g., with respect to vehicle 100.

In some demonstrative aspects, radar processor 104 may be configured to provide the radar information to a vehicle controller 108 of the vehicle 100, e.g., for autonomous driving of the vehicle 100.

In some demonstrative aspects, at least part of the functionality of radar processor 104 may be implemented as part of vehicle controller 108. In other aspects, the functionality of radar processor 104 may be implemented as part of any other element of radar device 101 and/or vehicle 100. In other aspects, radar processor 104 may be implemented, as a separate part of, or as part of any other element of radar device 101 and/or vehicle 100.

In some demonstrative aspects, vehicle controller 108 may be configured to control one or more functionalities, modes of operation, components, devices, systems, and/or elements of vehicle 100.

In some demonstrative aspects, vehicle controller 108 may be configured to control one or more vehicular systems of vehicle 100, e.g., as described below.

In some demonstrative aspects, the vehicular systems may include, for example, a steering system, a braking system, a driving system, and/or any other system of the vehicle 100.

In some demonstrative aspects, vehicle controller 108 may be configured to control radar device 101, and/or to process one or parameters, attributes and/or information from radar device 101.

In some demonstrative aspects, vehicle controller 108 may be configured, for example, to control the vehicular systems of the vehicle 100, for example, based on radar information from radar device 101 and/or one or more other sensors of the vehicle 100, e.g., Light Detection and Ranging (LIDAR) sensors, camera sensors, and/or the like.

In one example, vehicle controller 108 may control the steering system, the braking system, and/or any other vehicular systems of vehicle 100, for example, based on the information from radar device 101, e.g., based on one or more objects detected by radar device 101.

In other aspects, vehicle controller 108 may be configured to control any other additional or alternative functionalities of vehicle 100.

Some demonstrative aspects are described herein with respect to a radar device 101 implemented in a vehicle, e.g., vehicle 100. In other aspects a radar device, e.g., radar device 101, may be implemented as part of any other element of a traffic system or network, for example, as part of a road infrastructure, and/or any other element of a traffic network or system. Other aspects may be implemented with respect to any other system, environment, and/or apparatus, which may be implemented in any other object, environment, location, or place. For example, radar device 101 may be part of a non-vehicular device, which may be implemented, for example, in an indoor location, a stationary infrastructure outdoors, or any other location.

In some demonstrative aspects, radar device 101 may be configured to support security usage. In one example, radar device 101 may be configured to determine a nature of an operation, e.g., a human entry, an animal entry, an environmental movement, and the like, to identify a threat level of a detected event, and/or any other additional or alternative operations.

Some demonstrative aspects may be implemented with respect to any other additional or alternative devices and/or systems, for example, for a robot, e.g., as described below.

In other aspects, radar device 101 may be configured to support any other usages and/or applications.

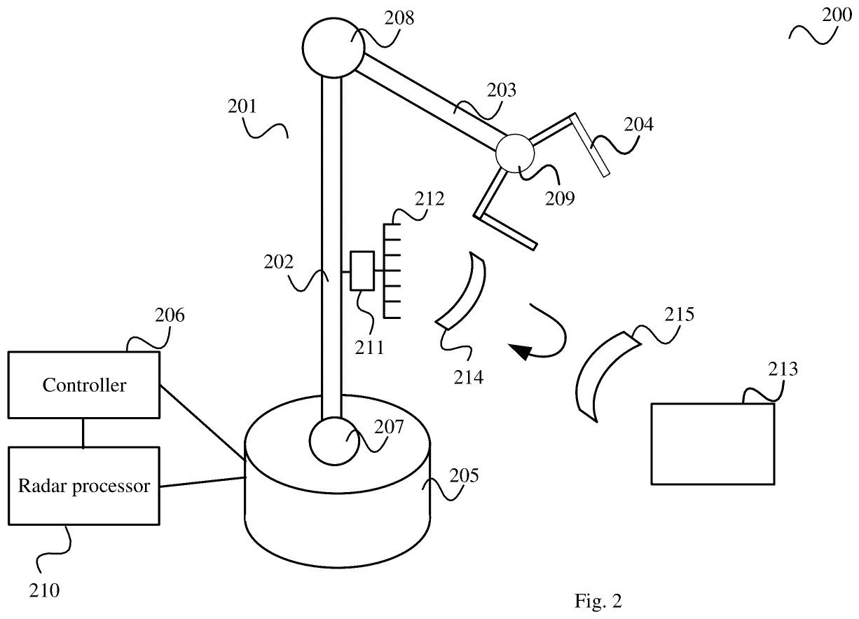

Reference is now made to FIG. 2, which schematically illustrates a block diagram of a robot 200 implementing a radar, in accordance with some demonstrative aspects.

In some demonstrative aspects, robot 200 may include a robot arm 201. The robot 200 may be implemented, for example, in a factory for handling an object 213, which may be, for example, a part that should be affixed to a product that is being manufactured. The robot arm 201 may include a plurality of movable members, for example, movable members 202, 203, 204, and a support 205. Moving the movable members 202, 203, and/or 204 of the robot arm 201, e.g., by actuation of associated motors, may allow physical interaction with the environment to carry out a task, e.g., handling the object 213.

In some demonstrative aspects, the robot arm 201 may include a plurality of joint elements, e.g., joint elements 207, 208, 209, which may connect, for example, the members 202, 203, and/or 204 with each other, and with the support 205. For example, a joint element 207, 208, 209 may have one or more joints, each of which may provide rotatable motion, e.g., rotational motion, and/or translatory motion, e.g., displacement, to associated members and/or motion of members relative to each other. The movement of the members 202, 203, 204 may be initiated by suitable actuators.

In some demonstrative aspects, the member furthest from the support 205, e.g., member 204, may also be referred to as the end-effector 204 and may include one or more tools, such as, a claw for gripping an object, a welding tool, or the like. Other members, e.g., members 202, 203, closer to the support 205, may be utilized to change the position of the end-effector 204, e.g., in three-dimensional space. For example, the robot arm 201 may be configured to function similarly to a human arm, e.g., possibly with a tool at its end.

In some demonstrative aspects, robot 200 may include a (robot) controller 206 configured to implement interaction with the environment, e.g., by controlling the robot arm's actuators, according to a control program, for example, in order to control the robot arm 201 according to the task to be performed.

In some demonstrative aspects, an actuator may include a component adapted to affect a mechanism or process in response to being driven. The actuator can respond to commands given by the controller 206 (the so-called activation) by performing mechanical movement. This means that an actuator, typically a motor (or electromechanical converter), may be configured to convert electrical energy into mechanical energy when it is activated (i.e., actuated).

In some demonstrative aspects, controller 206 may be in communication with a radar processor 210 of the robot 200.

In some demonstrative aspects, a radar fronted 211 and a radar antenna arrangement 212 may be coupled to the radar processor 210. In one example, radar fronted 211 and/or radar antenna arrangement 212 may be included, for example, as part of the robot arm 201.

In some demonstrative aspects, the radar frontend 211, the radar antenna arrangement 212 and the radar processor 210 may be operable as, and/or may be configured to form, a radar device. For example, antenna arrangement 212 may be configured to perform one or more functionalities of antenna arrangement 102 (FIG. 1), radar frontend 211 may be configured to perform one or more functionalities of radar frontend 103 (FIG. 1), and/or radar processor 210 may be configured to perform one or more functionalities of radar processor 104 (FIG. 1), e.g., as described above.

In some demonstrative aspects, for example, the radar frontend 211 and the antenna arrangement 212 may be controlled, e.g., by radar processor 210, to transmit a radio transmit signal 214.

In some demonstrative aspects, as shown in FIG. 2, the radio transmit signal 214 may be reflected by the object 213, resulting in an echo 215.

In some demonstrative aspects, the echo 215 may be received, e.g., via antenna arrangement 212 and radar frontend 211, and radar processor 210 may generate radar information, for example, by calculating information about position, speed (Doppler) and/or direction of the object 213, e.g., with respect to robot arm 201.

In some demonstrative aspects, radar processor 210 may be configured to provide the radar information to the robot controller 206 of the robot arm 201, e.g., to control robot arm 201. For example, robot controller 206 may be configured to control robot arm 201 based on the radar information, e.g., to grab the object 213 and/or to perform any other operation.

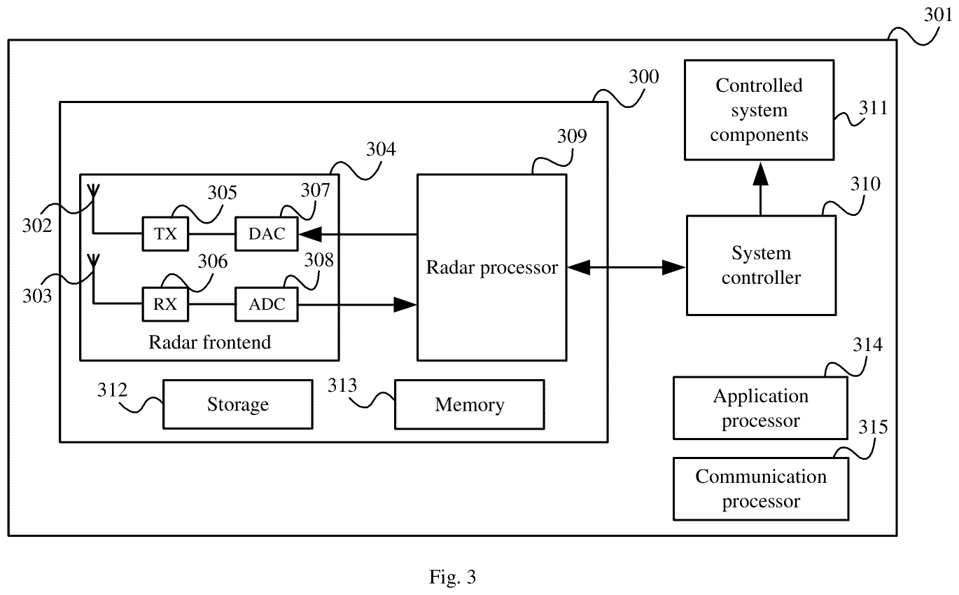

Reference is made to FIG. 3, which schematically illustrates a radar apparatus 300, in accordance with some demonstrative aspects.

In some demonstrative aspects, radar apparatus 300 may be implemented as part of a device or system 301, e.g., as described below.

For example, radar apparatus 300 may be implemented as part of, and/or may be configured to perform one or more operations and/or functionalities of, the devices or systems described above with reference to FIG. 1 and/or FIG. 2. In other aspects, radar apparatus 300 may be implemented as part of any other device or system 301.

In some demonstrative aspects, radar device 300 may include an antenna arrangement, which may include one or more transmit antennas 302 and one or more receive antennas 303. In other aspects, any other antenna arrangement may be implemented.

In some demonstrative aspects, radar device 300 may include a radar frontend 304, and a radar processor 309.

In some demonstrative aspects, as shown in FIG. 3, the one or more transmit antennas 302 may be coupled with a transmitter (or transmitter arrangement) 305 of the radar frontend 304; and/or the one or more receive antennas 303 may be coupled with a receiver (or receiver arrangement) 306 of the radar frontend 304, e.g., as described below.

In some demonstrative aspects, transmitter 305 may include one or more elements, for example, an oscillator, a power amplifier and/or one or more other elements, configured to generate radio transmit signals to be transmitted by the one or more transmit antennas 302, e.g., as described below.

In some demonstrative aspects, for example, radar processor 309 may provide digital radar transmit data values to the radar frontend 304. For example, radar frontend 304 may include a Digital-to-Analog Converter (DAC) 307 to convert the digital radar transmit data values to an analog transmit signal. The transmitter 305 may convert the analog transmit signal to a radio transmit signal which is to be transmitted by transmit antennas 302.

In some demonstrative aspects, receiver 306 may include one or more elements, for example, one or more mixers, one or more filters and/or one or more other elements, configured to process, down-convert, radio signals received via the one or more receive antennas 303, e.g., as described below.

In some demonstrative aspects, for example, receiver 306 may convert a radio receive signal received via the one or more receive antennas 303 into an analog receive signal. The radar frontend 304 may include an Analog-to-Digital Converter (ADC) 308 to generate digital radar reception data values based on the analog receive signal. For example, radar frontend 304 may provide the digital radar reception data values to the radar processor 309.

In some demonstrative aspects, radar processor 309 may be configured to process the digital radar reception data values, for example, to detect one or more objects, e.g., in an environment of the device/system 301. This detection may include, for example, the determination of information including one or more of range, speed (Doppler), direction, and/or any other information, of one or more objects, e.g., with respect to the system 301.

In some demonstrative aspects, radar processor 309 may be configured to provide the determined radar information to a system controller 310 of device/system 301. For example, system controller 310 may include a vehicle controller, e.g., if device/system 301 includes a vehicular device/system, a robot controller, e.g., if device/system 301 includes a robot device/system, or any other type of controller for any other type of device/system 301.

In some demonstrative aspects, the radar information from radar processor 309 may be processed, e.g., by system controller 310 and/or any other element of system 301, for example, in combination with information from one or more other information sources, for example, LiDAR information from a LiDAR processor, vision information from a vision-based processor, or the like.

In some demonstrative aspects, an environmental model of an environment of system 301 may be determined, e.g., by system controller 310 and/or any other element of system 301, for example, based on the radar information from radar processor 309, and/or the information from one or more other information sources.

In some demonstrative aspects, a driving policy system, e.g., which may be implemented by system controller 310 and/or any other element of system 301, may process the environmental model, for example, to decide on one or more actions, which may be taken.

In some demonstrative aspects, system controller 310 may be configured to control one or more controlled system components 311 of the system 301, e.g., a motor, a brake, steering, and the like, e.g., by one or more corresponding actuators, for example, based on the one or more action decisions.

In some demonstrative aspects, radar device 300 may include a storage 312 or a memory 313, e.g., to store information processed by radar 300, for example, digital radar reception data values being processed by the radar processor 309, radar information generated by radar processor 309, and/or any other data to be processed by radar processor 309.

In some demonstrative aspects, device/system 301 may include, for example, an application processor 314 and/or a communication processor 315, for example, to at least partially implement one or more functionalities of system controller 310 and/or to perform communication between system controller 310, radar device 300, the controlled system components 311, and/or one or more additional elements of device/system 301.

In some demonstrative aspects, radar device 300 may be configured to generate and transmit the radio transmit signal in a form, which may support determination of range, speed, and/or direction, e.g., as described below.

For example, a radio transmit signal of a radar may be configured to include a plurality of pulses. For example, a pulse transmission may include the transmission of short high-power bursts in combination with times during which the radar device listens for echoes.

For example, in order to more optimally support a highly dynamic situation, e.g., in an automotive scenario, a Continuous Wave (CW) may instead be used as the radio transmit signal. However, a continuous wave, e.g., with constant frequency, may support velocity determination, but may not allow range determination, e.g., due to the lack of a time mark that could allow distance calculation.

In some demonstrative aspects, radio transmit signal 105 (FIG. 1) may be transmitted according to technologies such as, for example, Frequency-Modulated Continuous Wave (FMCW) radar, Phase-Modulated Continuous Wave (PMCW) radar, Orthogonal Frequency Division Multiplexing (OFDM) radar, and/or any other type of radar technology, which may support determination of range, velocity, and/or direction, e.g., as described below.

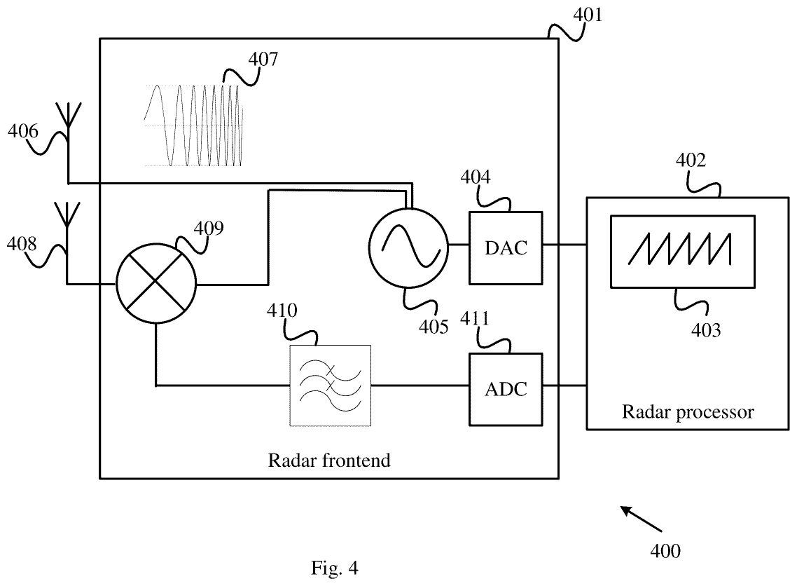

Reference is made to FIG. 4, which schematically illustrates a FMCW radar apparatus, in accordance with some demonstrative aspects.

In some demonstrative aspects, FMCW radar device 400 may include a radar frontend 401, and a radar processor 402. For example, radar frontend 304 (FIG. 3) may include one or more elements of, and/or may perform one or more operations and/or functionalities of, radar frontend 401; and/or radar processor 309 (FIG. 3) may include one or more elements of, and/or may perform one or more operations and/or functionalities of, radar processor 402.

In some demonstrative aspects, FMCW radar device 400 may be configured to communicate radio signals according to an FMCW radar technology, e.g., rather than sending a radio transmit signal with a constant frequency.

In some demonstrative aspects, radio frontend 401 may be configured to ramp up and reset the frequency of the transmit signal, e.g., periodically, for example, according to a saw tooth waveform 403. In other aspects, a triangle waveform, or any other suitable waveform may be used.

In some demonstrative aspects, for example, radar processor 402 may be configured to provide waveform 403 to frontend 401, for example, in digital form, e.g., as a sequence of digital values.

In some demonstrative aspects, radar frontend 401 may include a DAC 404 to convert waveform 403 into analog form, and to supply it to a voltage-controlled oscillator 405. For example, oscillator 405 may be configured to generate an output signal, which may be frequency-modulated in accordance with the waveform 403.

In some demonstrative aspects, oscillator 405 may be configured to generate the output signal including a radio transmit signal, which may be fed to and sent out by one or more transmit antennas 406.

In some demonstrative aspects, the radio transmit signal generated by the oscillator 405 may have the form of a sequence of chirps 407, which may be the result of the modulation of a sinusoid with the saw tooth waveform 403.

In one example, a chirp 407 may correspond to the sinusoid of the oscillator signal frequency-modulated by a “tooth” of the saw tooth waveform 403, e.g., from the minimum frequency to the maximum frequency.

In some demonstrative aspects, FMCW radar device 400 may include one or more receive antennas 408 to receive a radio receive signal. The radio receive signal may be based on the echo of the radio transmit signal, e.g., in addition to any noise, interference, or the like.

In some demonstrative aspects, radar frontend 401 may include a mixer 409 to mix the radio transmit signal with the radio receive signal into a mixed signal.

In some demonstrative aspects, radar frontend 401 may include a filter, e.g., a Low Pass Filter (LPF) 410, which may be configured to filter the mixed signal from the mixer 409 to provide a filtered signal. For example, radar frontend 401 may include an ADC 411 to convert the filtered signal into digital reception data values, which may be provided to radar processor 402. In another example, the filter 410 may be a digital filter, and the ADC 411 may be arranged between the mixer 409 and the filter 410.

In some demonstrative aspects, radar processor 402 may be configured to process the digital reception data values to provide radar information, for example, including range, speed (velocity/Doppler), and/or direction (AoA) information of one or more objects.

In some demonstrative aspects, radar processor 402 may be configured to perform a first Fast Fourier Transform (FFT) (also referred to as “range FFT”) to extract a delay response, which may be used to extract range information, and/or a second FFT (also referred to as “Doppler FFT”) to extract a Doppler shift response, which may be used to extract velocity information, from the digital reception data values.

In other aspects, any other additional or alternative methods may be utilized to extract range information. In one example, in a digital radar implementation, a correlation with the transmitted signal may be used, e.g., according to a matched filter implementation.

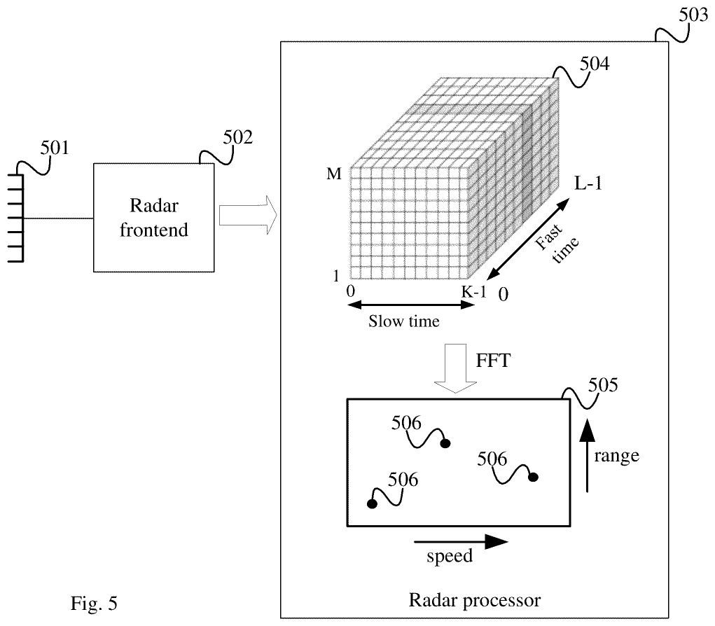

Reference is made to FIG. 5, which schematically illustrates an extraction scheme, which may be implemented to extract range and speed (Doppler) estimations from digital reception radar data values, in accordance with some demonstrative aspects. For example, radar processor 104 (FIG. 1), radar processor 210 (FIG. 2), radar processor 309 (FIG. 3), and/or radar processor 402 (FIG. 4), may be configured to extract range and/or speed (Doppler) estimations from digital reception radar data values according to one or more aspects of the extraction scheme of FIG. 5.

In some demonstrative aspects, as shown in FIG. 5, a radio receive signal, e.g., including echoes of a radio transmit signal, may be received by a receive antenna array 501. The radio receive signal may be processed by a radio radar frontend 502 to generate digital reception data values, e.g., as described above. The radio radar frontend 502 may provide the digital reception data values to a radar processor 503, which may process the digital reception data values to provide radar information, e.g., as described above.

In some demonstrative aspects, the digital reception data values may be represented in the form of a data cube 504. For example, the data cube 504 may include digitized samples of the radio receive signal, which is based on a radio signal transmitted from a transmit antenna and received by M receive antennas. In some demonstrative aspects, for example, with respect to a MIMO implementation, there may be multiple transmit antennas, and the number of samples may be multiplied accordingly.

In some demonstrative aspects, a layer of the data cube 504, for example, a horizontal layer of the data cube 504, may include samples of an antenna, e.g., a respective antenna of the M antennas.

In some demonstrative aspects, data cube 504 may include samples for K chirps. For example, as shown in FIG. 5, the samples of the chirps may be arranged in a so-called “slow time”-direction.

In some demonstrative aspects, the data cube 504 may include L samples, e.g., L=512 or any other number of samples, for a chirp, e.g., per each chirp. For example, as shown in FIG. 5, the samples per chirp may be arranged in a so-called “fast time”-direction of the data cube 504.

In some demonstrative aspects, radar processor 503 may be configured to process a plurality of samples, e.g., L samples collected for each chirp and for each antenna, by a first FFT. The first FFT may be performed, for example, for each chirp and each antenna, such that a result of the processing of the data cube 504 by the first FFT may again have three dimensions, and may have the size of the data cube 504 while including values for L range bins, e.g., instead of the values for the L sampling times.

In some demonstrative aspects, radar processor 503 may be configured to process the result of the processing of the data cube 504 by the first FFT, for example, by processing the result according to a second FFT along the chirps, e.g., for each antenna and for each range bin.

For example, the first FFT may be in the “fast time” direction, and the second FFT may be in the “slow time” direction.

In some demonstrative aspects, the result of the second FFT may provide, e.g., when aggregated over the antennas, a range/Doppler (R/D) map 505. The R/D map may have FFT peaks 506, for example, including peaks of FFT output values (in terms of absolute values) for certain range/speed combinations, e.g., for range/Doppler bins. For example, a range/Doppler bin may correspond to a range bin and a Doppler bin. For example, radar processor 503 may consider a peak as potentially corresponding to an object, e.g., of the range and speed corresponding to the peak's range bin and speed bin.

In some demonstrative aspects, the extraction scheme of FIG. 5 may be implemented for an FMCW radar, e.g., FMCW radar 400 (FIG. 4), as described above. In other aspects, the extraction scheme of FIG. 5 may be implemented for any other radar type. In one example, the radar processor 503 may be configured to determine a range/Doppler map 505 from digital reception data values of a PMCW radar, an OFDM radar, or any other radar technologies. For example, in adaptive or cognitive radar, the pulses in a frame, the waveform and/or modulation may be changed over time, e.g., according to the environment.

Referring back to FIG. 3, in some demonstrative aspects, receive antenna arrangement 303 may be implemented using a receive antenna array having a plurality of receive antennas (or receive antenna elements). For example, radar processor 309 may be configured to determine an angle of arrival of the received radio signal, e.g., echo 107 (FIG. 1) and/or echo 215 (FIG. 2). For example, radar processor 309 may be configured to determine a direction of a detected object, e.g., with respect to the device/system 301, for example, based on the angle of arrival of the received radio signal, e.g., as described below.

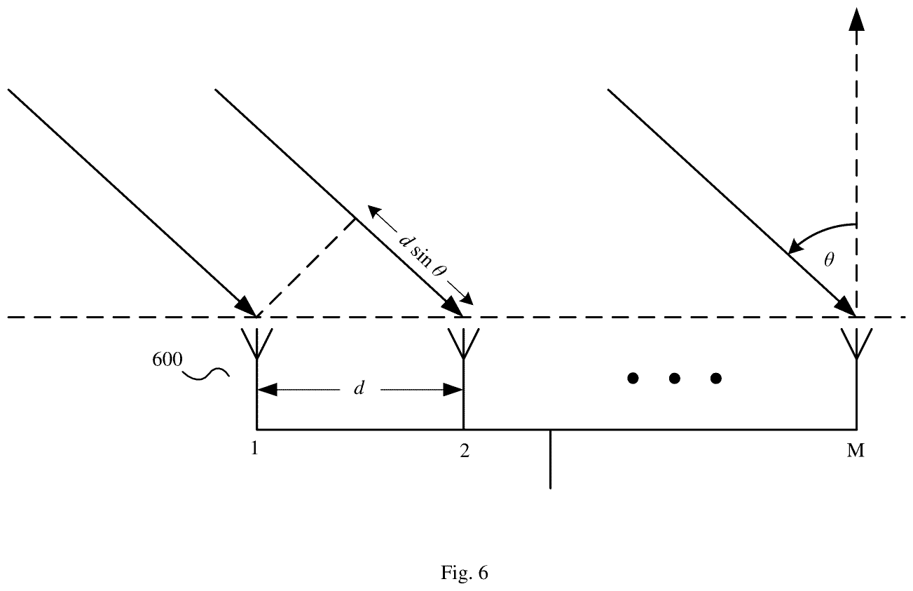

Reference is made to FIG. 6, which schematically illustrates an angle-determination scheme, which may be implemented to determine Angle of Arrival (AoA) information based on an incoming radio signal received by a receive antenna array 600, in accordance with some demonstrative aspects.

FIG. 6 depicts an angle-determination scheme based on received signals at the receive antenna array.

In some demonstrative aspects, for example, in a virtual MIMO array, the angle-determination may also be based on the signals transmitted by the array of Tx antennas.

FIG. 6 depicts a one-dimensional angle-determination scheme. Other multi-dimensional angle determination schemes, e.g., a two-dimensional scheme or a three-dimensional scheme, may be implemented.

In some demonstrative aspects, as shown in FIG. 6, the receive antenna array 600 may include M antennas (numbered, from left to right, 1 to M).

As shown by the arrows in FIG. 6, it is assumed that an echo is coming from an object located at the top left direction. Accordingly, the direction of the echo, e.g., the incoming radio signal, may be towards the bottom right. According to this example, the further to the left a receive antenna is located, the earlier it will receive a certain phase of the incoming radio signal.

For example, a phase difference, denoted Δφ, between two antennas of the receive antenna array 600 may be determined, e.g., as follows:

$$Δ φ = \frac{2 π}{λ} \cdot d \cdot sin ( θ )$$

wherein λ denotes a wavelength of the incoming radio signal, d denotes a distance between the two antennas, and θ denotes an angle of arrival of the incoming radio signal, e.g., with respect to a normal direction of the array.

In some demonstrative aspects, radar processor 309 (FIG. 3) may be configured to utilize this relationship between phase and angle of the incoming radio signal, for example, to determine the angle of arrival of echoes, for example by performing an FFT, e.g., a third FFT (“angular FFT”) over the antennas.

In some demonstrative aspects, multiple transmit antennas, e.g., in the form of an antenna array having multiple transmit antennas, may be used, for example, to increase the spatial resolution, e.g., to provide high-resolution radar information. For example, a MIMO radar device may utilize a virtual MIMO radar antenna, which may be formed as a convolution of a plurality of transmit antennas convolved with a plurality of receive antennas.

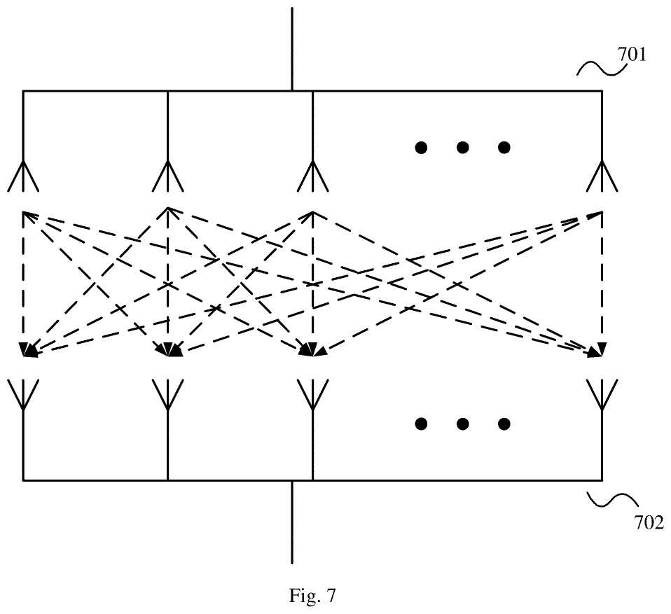

Reference is made to FIG. 7, which schematically illustrates a MIMO radar antenna scheme, which may be implemented based on a combination of Transmit (Tx) and Receive (Rx) antennas, in accordance with some demonstrative aspects.

In some demonstrative aspects, as shown in FIG. 7, a radar MIMO arrangement may include a transmit antenna array 701 and a receive antenna array 702. For example, the one or more transmit antennas 302 (FIG. 3) may be implemented to include transmit antenna array 701, and/or the one or more receive antennas 303 (FIG. 3) may be implemented to include receive antenna array 702.

In some demonstrative aspects, antenna arrays including multiple antennas both for transmitting the radio transmit signals and for receiving echoes of the radio transmit signals, may be utilized to provide a plurality of virtual channels as illustrated by the dashed lines in FIG. 7. For example, a virtual channel may be formed as a convolution, for example, as a Kronecker product, between a transmit antenna and a receive antenna, e.g., representing a virtual steering vector of the MIMO radar.

In some demonstrative aspects, a transmit antenna, e.g., each transmit antenna, may be configured to send out an individual radio transmit signal, e.g., having a phase associated with the respective transmit antenna.

For example, an array of N transmit antennas and M receive antennas may be implemented to provide a virtual MIMO array of size N×M. For example, the virtual MIMO array may be formed according to the Kronecker product operation applied to the Tx and Rx steering vectors.

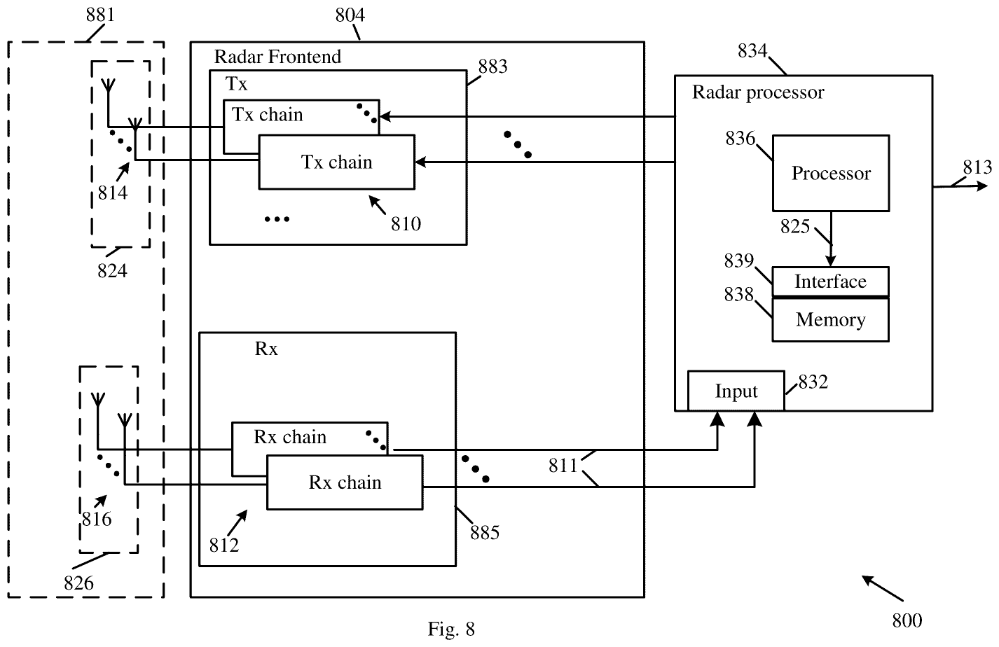

FIG. 8 is a schematic block diagram illustration of elements of a radar device 800, in accordance with some demonstrative aspects. For example, radar device 101 (FIG. 1), radar device 300 (FIG. 3), and/or radar device 400 (FIG. 4), may include one or more elements of radar device 800, and/or may perform one or more operations and/or functionalities of radar device 800.

In some demonstrative aspects, as shown in FIG. 8, radar device 800 may include a radar frontend 804 and a radar processor 834. For example, radar frontend 103 (FIG. 1), radar frontend 211 (FIG. 1), radar frontend 304 (FIG. 3), radar frontend 401 (FIG. 4), and/or radar frontend 502 (FIG. 5), may include one or more elements of radar frontend 804, and/or may perform one or more operations and/or functionalities of radar frontend 804.

In some demonstrative aspects, radar frontend 804 may be implemented as part of a MIMO radar utilizing a MIMO radar antenna 881 including a plurality of Tx antennas 814 configured to transmit a plurality of Tx RF signals (also referred to as “Tx radar signals”); and a plurality of Rx antennas 816 configured to receive a plurality of Rx RF signals (also referred to as “Rx radar signals”), for example, based on the Tx radar signals, e.g., as described below.

In some demonstrative aspects, MIMO antenna array 881, antennas 814, and/or antennas 816 may include or may be part of any type of antennas suitable for transmitting and/or receiving radar signals. For example, MIMO antenna array 881, antennas 814, and/or antennas 816, may be implemented as part of any suitable configuration, structure, and/or arrangement of one or more antenna elements, components, units, assemblies, and/or arrays. For example, MIMO antenna array 881, antennas 814, and/or antennas 816, may be implemented as part of a phased array antenna, a multiple element antenna, a set of switched beam antennas, and/or the like. In some aspects, MIMO antenna array 881, antennas 814, and/or antennas 816, may be implemented to support transmit and receive functionalities using separate transmit and receive antenna elements. In some aspects, MIMO antenna array 881, antennas 814, and/or antennas 816, may be implemented to support transmit and receive functionalities using common and/or integrated transmit/receive elements.

In some demonstrative aspects, MIMO radar antenna 881 may include a rectangular MIMO antenna array, and/or curved array, e.g., shaped to fit a vehicle design.

In other aspects, any other form, shape, and/or arrangement of MIMO radar antenna 881 may be implemented.

In some demonstrative aspects, radar frontend 804 may include one or more radios configured to generate and transmit the Tx RF signals via Tx antennas 814; and/or to process the Rx RF signals received via Rx antennas 816, e.g., as described below.

In some demonstrative aspects, radar frontend 804 may include at least one transmitter (Tx) 883 including circuitry and/or logic configured to generate and/or transmit the Tx radar signals via Tx antennas 814.

In some demonstrative aspects, radar frontend 804 may include at least one receiver (Rx) 885 including circuitry and/or logic to receive and/or process the Rx radar signals received via Rx antennas 816, for example, based on the Tx radar signals.

In some demonstrative aspects, transmitter 883, and/or receiver 885 may include circuitry; logic; Radio Frequency (RF) elements, circuitry and/or logic; baseband elements, circuitry and/or logic; modulation elements, circuitry and/or logic; demodulation elements, circuitry and/or logic; amplifiers; analog to digital and/or digital to analog converters; filters; and/or the like.

In some demonstrative aspects, transmitter 883 may include a plurality of Tx chains 810 configured to generate and transmit the Tx RF signals via Tx antennas 814, e.g., respectively; and/or receiver 885 may include a plurality of Rx chains 812 configured to receive and process the Rx RF signals received via the Rx antennas 816, e.g., respectively.

In some demonstrative aspects, radar processor 834 may be configured to generate radar information 813, for example, based on the radar signals communicated by MIMO radar antenna 881, e.g., as described below. For example, radar processor 104 (FIG. 1), radar processor 210 (FIG. 2), radar processor 309 (FIG. 3), radar processor 402 (FIG. 4), and/or radar processor 503 (FIG. 5), may include one or more elements of radar processor 834, and/or may perform one or more operations and/or functionalities of radar processor 834.

In some demonstrative aspects, radar processor 834 may be configured to generate radar information 813, for example, based on radar Rx data 811 received from the plurality of Rx chains 812. For example, radar Rx data 811 may be based on the radar Rx signals received via the Rx antennas 816.

In some demonstrative aspects, radar processor 834 may include an input 832 to receive radar input data, e.g., including the radar Rx data 811 from the plurality of Rx chains 812.

In some demonstrative aspects, radar processor 834 may include, or may be implemented, partially or entirely, by circuitry and/or logic, e.g., one or more processors including circuitry and/or logic, memory circuitry and/or logic. Additionally or alternatively, one or more functionalities of radar processor 834 may be implemented by logic, which may be executed by a machine and/or one or more processors, e.g., as described below.

In some demonstrative aspects, radar processor 834 may include at least one processor 836, which may be configured, for example, to process the radar Rx data 811, and/or to perform one or more operations, methods, and/or algorithms.

In some demonstrative aspects, radar processor 834 may include at least one memory 838, e.g., coupled to the processor 836. For example, memory 838 may be configured to store data processed by radar processor 834. For example, memory 838 may store, e.g., at least temporarily, at least some of the information processed by the processor 836, and/or logic to be utilized by the processor 836.

In some demonstrative aspects, processor 836 may interface with memory 838, for example, via a memory interface 839.

In some demonstrative aspects, processor 836 may be configured to access memory 838, e.g., to write data to memory 838 and/or to read data from memory 838, for example, via memory interface 839.

In some demonstrative aspects, memory 838 may be configured to store at least part of the radar data, e.g., some of the radar Rx data or all of the radar Rx data, for example, for processing by processor 836, e.g., as described below.

In some demonstrative aspects, memory 838 may be configured to store processed data, which may be generated by processor 836, for example, during the process of generating the radar information 813, e.g., as described below.

In some demonstrative aspects, memory 838 may be configured to store range information and/or Doppler information, which may be generated by processor 836, for example, based on the radar Rx data. In one example, the range information and/or Doppler information may be determined based on a Cross-Correlation (XCORR) operation, which may be applied to the radar Rx data. Any other additional or alternative operation, algorithm, and/or procedure may be utilized to generate the range information and/or Doppler information.

In some demonstrative aspects, memory 838 may be configured to store AoA information, which may be generated by processor 836, for example, based on the radar Rx data, the range information and/or Doppler information. In one example, the AoA information may be determined based on an AoA estimation algorithm. Any other additional or alternative operation, algorithm, and/or procedure may be utilized to generate the AoA information.

In some demonstrative aspects, radar processor 834 may be configured to generate the radar information 813 including one or more of range information, Doppler information, and/or AoA information.

In some demonstrative aspects, the radar information 813 may include Point Cloud 1 (PC1) information, for example, including raw point cloud estimations, e.g., Range, Radial Velocity, Azimuth, and/or Elevation.

In some demonstrative aspects, the radar information 813 may include additional information, which may be, for example, based on the raw point cloud estimations, and/or may be related to the raw point cloud estimations.

In some demonstrative aspects, the radar information 813 may include metadata information corresponding to the raw point cloud estimations.

In some demonstrative aspects, the radar information 813 may include, for example, information relating to a reliability level of the raw point cloud estimations, information relating to one or more parameters, conditions and/or criteria implemented in determining the raw point cloud estimations, and/or any other suitable additional or alternative information.

For example, the radar information 813 may include Log Likelihood Ratio (LLR) information corresponding to the raw point cloud estimations, Radar Cross Section (RCS) estimation information, Signal to Noise Ratio (SNR) estimation information, and/or any other suitable additional or alternative information.

In some demonstrative aspects, the radar information 813 may include Point Cloud 2 (PC2) information, which may be generated, for example, based on the PC1 information. For example, the PC2 information may include clustering information, tracking information, e.g., tracking of probabilities and/or density functions, bounding box information, classification information, orientation information, and the like. In one example, the PC2 information may be based on one or more temporal filtering techniques, which may be applied to the PC1 information, for example, for temporal filtering of multiple frames and/or multiple PC1 instances.

In some demonstrative aspects, the radar information 813 may include target tracking information corresponding to a plurality of targets in an environment of the radar device 800, e.g., as described below.

In some demonstrative aspects, radar processor 834 may be configured to generate the radar information 813 in the form of four Dimensional (4D) image information, e.g., a cube, which may represent 4D information corresponding to one or more detected targets.

In some demonstrative aspects, the 4D image information may include, for example, range values, e.g., based on the range information, velocity values, e.g., based on the Doppler information, azimuth values, e.g., based on azimuth AoA information, elevation values, e.g., based on elevation AoA information, and/or any other values.

In some demonstrative aspects, radar processor 834 may be configured to generate the radar information 813 in any other form, and/or including any other additional or alternative information.

In some demonstrative aspects, radar processor 834 may be configured to process the signals communicated via MIMO radar antenna 881 as signals of a virtual MIMO array formed by a convolution of the plurality of Rx antennas 816 and the plurality of Tx antennas 814.

In some demonstrative aspects, radar frontend 804 and/or radar processor 834 may be configured to utilize MIMO techniques, for example, to support a reduced physical array aperture, e.g., an array size, and/or utilizing a reduced number of antenna elements. For example, radar frontend 804 and/or radar processor 834 may be configured to transmit orthogonal signals via one or more Tx arrays 824 including a plurality of N elements, e.g., Tx antennas 814, and processing received signals via one or more Rx arrays 826 including a plurality of M elements, e.g., Rx antennas 816.

In some demonstrative aspects, utilizing the MIMO technique of transmission of the orthogonal signals from the Tx arrays 824 with N elements and processing the received signals in the Rx arrays 826 with M elements may be equivalent, e.g., under a far field approximation, to a radar utilizing transmission from one antenna and reception with N*M antennas. For example, radar frontend 804 and/or radar processor 834 may be configured to utilize MIMO antenna array 881 as a virtual array having an equivalent array size of N*M, which may define locations of virtual elements, for example, as a convolution of locations of physical elements, e.g., the antennas 814 and/or 816.

In some demonstrative aspects, a radar system may include a plurality of radar devices 800. For example, vehicle 100 (FIG. 1) may include a plurality of radar devices 800, e.g., as described below.

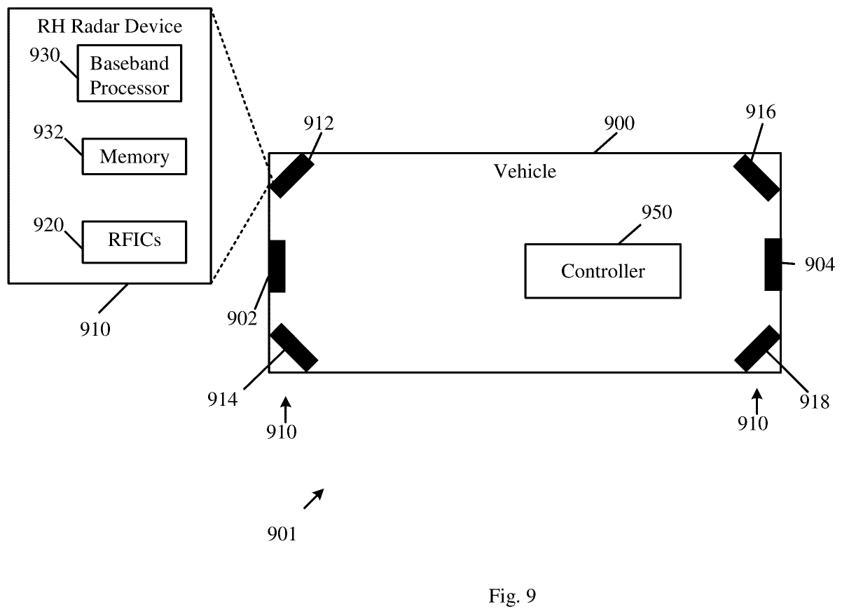

Reference is made to FIG. 9, which schematically illustrates a radar system 901 including a plurality of Radio Head (RH) radar devices (also referred to as RHs) 910 implemented in a vehicle 900, in accordance with some demonstrative aspects.

In some demonstrative aspects, as shown in FIG. 9, the plurality of RH radar devices 910 may be located, for example, at a plurality of positions around vehicle 900, for example, to provide radar sensing at a large field of view around vehicle 900, e.g., as described below.

In some demonstrative aspects, as shown in FIG. 9, the plurality of RH radar devices 910 may include, for example, six RH radar devices 910, e.g., as described below.

In some demonstrative aspects, the plurality of RH radar devices 910 may be located, for example, at a plurality of positions around vehicle 900, which may be configured to support 360-degrees radar sensing, e.g., a field of view of 360 degrees surrounding the vehicle 900, e.g., as described below.

In one example, the 360-degrees radar sensing may allow to provide a radar-based view of substantially all surroundings around vehicle 900, e.g., as described below.

In other aspects, the plurality of RH radar devices 910 may include any other number of RH radar devices 910, e.g., less than six radar devices or more than six radar devices.

In other aspects, the plurality of RH radar devices 910 may be positioned at any other locations and/or according to any other arrangement, which may support radar sensing at any other field of view around vehicle 900, e.g., 360-degrees radar sensing or radar sensing of any other field of view.

In some demonstrative aspects, as shown in FIG. 9, vehicle 900 may include a first RH radar device 902, e.g., a front RH, at a front-side of vehicle 900.

In some demonstrative aspects, as shown in FIG. 9, vehicle 900 may include a second RH radar device 904, e.g., a back RH, at a back-side of vehicle 900.

In some demonstrative aspects, as shown in FIG. 9, vehicle 900 may include one or more of RH radar devices at one or more respective corners of vehicle 900. For example, vehicle 900 may include a first corner RH radar device 912 at a first corner of vehicle 900, a second corner RH radar device 914 at a second corner of vehicle 900, a third corner RH radar device 916 at a third corner of vehicle 900, and/or a fourth corner RH radar device 918 at a fourth corner of vehicle 900.

In some demonstrative aspects, vehicle 900 may include one, some, or all, of the plurality of RH radar devices 910 shown in FIG. 9. For example, vehicle 900 may include the front RH radar device 902 and/or back RH radar device 904.

In other aspects, vehicle 900 may include any other additional or alternative radar devices, for example, at any other additional or alternative positions around vehicle 900. In one example, vehicle 900 may include a side radar, e.g., on a side of vehicle 900.

In some demonstrative aspects, as shown in FIG. 9, vehicle 900 may include a radar system controller 950 configured to control one or more, e.g., some or all, of the RH radar devices 910.

In some demonstrative aspects, at least part of the functionality of radar system controller 950 may be implemented by a dedicated controller, e.g., a dedicated system controller or central controller, which may be separate from the RH radar devices 910, and may be configured to control some or all of the RH radar devices 910.

In some demonstrative aspects, at least part of the functionality of radar system controller 950 may be implemented as part of at least one RH radar device 910.

In some demonstrative aspects, at least part of the functionality of radar system controller 950 may be implemented by a radar processor of an RH radar device 910. For example, radar processor 834 (FIG. 8) may include one or more elements of radar system controller 950, and/or may perform one or more operations and/or functionalities of radar system controller 950.

In some demonstrative aspects, at least part of the functionality of radar system controller 950 may be implemented by a system controller of vehicle 900. For example, vehicle controller 108 (FIG. 1) may include one or more elements of radar system controller 950, and/or may perform one or more operations and/or functionalities of radar system controller 950.

In other aspects, one or more functionalities of system controller 950 may be implemented as part of any other element of vehicle 900.

In some demonstrative aspects, as shown in FIG. 9, an RH radar device 910 of the plurality of RH radar devices 910, may include a baseband processor 930 (also referred to as a “Baseband Processing Unit (BPU)”), which may be configured to control communication of radar signals by the RH radar device 910, and/or to process radar signals communicated by the RH radar device 910. For example, baseband processor 930 may include one or more elements of radar processor 834 (FIG. 8), and/or may perform one or more operations and/or functionalities of radar processor 834 (FIG. 8).

In other aspects, an RH radar device 910 of the plurality of RH radar devices 910 may exclude one or more, e.g., some or all, functionalities of baseband processor 930. For example, controller 950 may be configured to perform one or more, e.g., some or all, functionalities of the baseband processor 930 for the RH.

In one example, controller 950 may be configured to perform baseband processing for all RH radar devices 910, and all RH radio devices 910 may be implemented without baseband processors 930.

In another example, controller 950 may be configured to perform baseband processing for one or more first RH radar devices 910, and the one or more first RH radio devices 910 may be implemented without baseband processors 930; and/or one or more second RH radar devices 910 may be implemented with one or more functionalities, e.g., some or all functionalities, of baseband processors 930.

In another example, one or more, e.g., some or all, RH radar devices 910 may be implemented with one or more functionalities, e.g., partial functionalities or full functionalities, of baseband processors 930.

In some demonstrative aspects, baseband processor 930 may include one or more components and/or elements configured for digital processing of radar signals communicated by the RH radar device 910, e.g., as described below.

In some demonstrative aspects, baseband processor 930 may include one or more FFT engines, matrix multiplication engines, DSP processors, and/or any other additional or alternative baseband, e.g., digital, processing components.

In some demonstrative aspects, as shown in FIG. 9, RH radar device 910 may include a memory 932, which may be configured to store data processed by, and/or to be processed by, baseband processor 930. For example, memory 932 may include one or more elements of memory 838 (FIG. 8), and/or may perform one or more operations and/or functionalities of memory 838 (FIG. 8).

In some demonstrative aspects, memory 932 may include an internal memory, and/or an interface to one or more external memories, e.g., an external Double Data Rate (DDR) memory, and/or any other type of memory.

In other aspects, an RH radar device 910 of the plurality of RH radar devices 910 may exclude memory 932. For example, the RH radar device 910 may be configured to provide radar data to controller 950, e.g., in the form of raw radar data.

In some demonstrative aspects, as shown in FIG. 9, RH radar device 910 may include one or more RF units, e.g., in the form of one or more RF Integrated Chips (RFICs) 920, which may be configured to communicate radar signals, e.g., as described below.

For example, an RFIC 920 may include one or more elements of front-end 804 (FIG. 8), and/or may perform one or more operations and/or functionalities of front-end 804 (FIG. 8).

In some demonstrative aspects, the plurality of RFICs 920 may be operable to form a radar antenna array including one or more Tx antenna arrays and one or more Rx antenna arrays.

For example, the plurality of RFICs 920 may be operable to form MIMO radar antenna 881 (FIG. 8) including Tx arrays 824 (FIG. 8), and/or Rx arrays 826 (FIG. 8).

In some demonstrative aspects, a radar device, e.g., as described above with reference to FIGS. 1-9, may be configured to provide a technical solution to mitigate interference between the radar device and one or more other radar devices, e.g., as described below.

In some demonstrative aspects, a radar device, e.g., as described above with reference to FIGS. 1-9, may be configured to implement one or more operations and/or functionalities of a transmission scheme, which may be configured to provide a technical solution to support mitigation of interference between the radar device and one or more other radar devices, e.g., as described below.

In some demonstrative aspects, a radar device, e.g., as described above with reference to FIGS. 1-9, may be configured to implement one or more operations and/or functionalities of a transmission scheme, which may be configured to provide a technical solution to support one or more use cases, deployments, and/or implementations, for example, where there is no central management entity, e.g., a central Medium Access Controller (MAC), which may share radar resources between radar radios (also referred to as “radar units”) of vehicles on the road, e.g., as described below.

In some demonstrative aspects, a radar device, e.g., as described above with reference to FIGS. 1-9, may be configured to implement one or more operations and/or functionalities of a transmission scheme, which may be configured to provide a technical solution to support one or more use cases, deployments, and/or implementations, where a vehicle, e.g., each vehicle, may operate as a standalone unit that must guarantee reliable radar information for safe operation, e.g., as described below.

For example, radar units may be configured to transmit in radio transmit configurations with overlap of frames, e.g., an overlap in frame time, frequency allocation, polarization, code, resource, and/or any other suitable attribute, configuration and/or parameter of radar transmissions.

For example, in some use cases and/or scenarios, an overlap between transmissions from two or more radar devices, e.g., even a partial overlap, may be harmful, e.g., very harmful, for example, at a radar device, which may process received radar signals (“receiving radar device” or “victim radar device”). For example, the receiving radar device may be at risk of confusing its own signals with signals received based on transmissions from other vehicles.

For example, this risk of the radar interference may grow over time, for example, as an increasing number of radar radios may be used per vehicle. For example, the risk of the radar interference may grow as radar systems are implemented by an increasing number of new vehicles, and/or as stronger transmit powers may be used. In one example, this risk of the radar interference may be relatively high in crowded areas, e.g., parking lots, or the like.

For example, in some use cases, scenarios, and/or implementations, the radar interference may result in a phenomena of raising a noise floor at the receiving radar device.

For example, this phenomena may occur in case an interfering radar utilizes a different waveform from a waveform utilized by the receiving radar device.

For example, the waveform of the interfering radar may have a different modulation, e.g., different chirp parameters, a different pseudo orthogonalization method between transmitters, different codes, a different frame structure, and/or any other suitable attribute, configuration, setting and/or parameter. For example, in many cases, such a difference between the waveform of the interferer and the waveform of the receiving radar device may not necessitate all of the above to appear as noise.

For example, in some use cases, scenarios, and/or implementations, the radar interference may result in a phenomena of creating a ghost target (ghost) or ghosts at the receiving radar device.

For example, these ghosts may appear in case the interfering radar utilizes a similar waveform to the waveform of the receiving radar device. For example, the waveform of the interfering radar may have a similar modulation, e.g., similar chirp parameters, a similar pseudo orthogonalization method between transmitters, similar codes, a similar frame structure, and/or any other suitable attribute, configuration, setting and/or parameter, which may be similar to the waveform utilized by the receiving radar device.

In some demonstrative aspects, a radar device, e.g., as described above with reference to FIGS. 1-9, may be configured to implement one or more operations and/or functionalities of a transmission scheme, which may be configured to provide a technical solution to support mitigation of interference between the radar device and one or more other radar devices, for example, by mitigating ghost targets, e.g., as described below.

In some demonstrative aspects, a radar device, e.g., as described above with reference to FIGS. 1-9, may be configured to implement one or more operations and/or functionalities of a transmission scheme, which may be configured to provide a technical solution to support mitigation of interference between radar devices using similar radar waveforms, e.g., as described below.

In some demonstrative aspects, a radar device, e.g., as described above with reference to FIGS. 1-9, may be configured to implement one or more operations and/or functionalities of a transmission scheme, which may be configured to provide a technical solution to support mitigation of interference between radar devices, which may use identical radar waveforms, e.g., as described below.

In one example, in some cases, radar systems from a same vendor and/or from a same vehicle Original Equipment Manufacturer (OEM) may utilize identical radar waveforms.

For example, in a fleet implementation there may be a relatively high probability that several, or even many, vehicles equipped with radar units from a same vendor and/or vehicle OEM may be in vicinity to each other, for example, at a hub, at large sports events, shows, dense urban locations, or the like.

In another example, in some cases, two radars may share the same waveform design, for example, in accordance with a standard and/or other agreed definition with respect to one or more parameters, e.g., chirp parameters, array pseudo orthogonalization, codes, frame structure, or the like. For example, radar devices implemented in accordance with a future standard may be required to utilize similar waveforms and/or frame structures, for example, as may be dictated by such future standard.

In some demonstrative aspects, a radar device, e.g., as described above with reference to FIGS. 1-9, may be configured to implement one or more operations and/or functionalities of a transmission scheme, which may be configured to provide a technical solution to support a more robust and successful future specification and/or standardization.

In some demonstrative aspects, a radar device, e.g., as described above with reference to FIGS. 1-9, may be configured to implement one or more operations and/or functionalities of a transmission scheme, which may be configured to provide a technical solution to reduce the power of ghosts, e.g., as described below.

In some demonstrative aspects, a radar device, e.g., as described above with reference to FIGS. 1-9, may be configured to implement one or more operations and/or functionalities of a transmission scheme, which may be configured to provide a technical solution to reduce the power of one or more, e.g., some or all, ghosts, for example, by smearing the ghosts, for example, in the range domain, e.g., as described below.

In some demonstrative aspects, a radar device, e.g., as described above with reference to FIGS. 1-9, may be configured to implement one or more operations and/or functionalities of a transmission scheme, which may be configured to provide a technical solution to reduce the power of the ghosts, for example, by providing a ghost power reduction of about 20 dB, or any other suitable reduction, e.g., as described below.

For example, in some cases, the ghost power reduction may be dependent on a frame structure and/or a particular implementation.

In some demonstrative aspects, a radar device, e.g., as described above with reference to FIGS. 1-9, may be configured to implement one or more operations and/or functionalities of a transmission scheme, which may provide a technical solution to reduce the power of the ghosts, for example, without or with minimal penalty on ideal performance, e.g., of a scenario without interference.

In some demonstrative aspects, a radar device, e.g., as described above with reference to FIGS. 1-9, may be configured to implement one or more operations and/or functionalities of a transmission scheme, which may provide a technical solution to support a relatively simple implementation.

In some demonstrative aspects, a radar device, e.g., as described above with reference to FIGS. 1-9, may be configured to implement one or more operations and/or functionalities of a transmission scheme, which may provide a technical solution to provide a range smearing effect in a range domain, e.g., as described below.

In some demonstrative aspects, the range smearing effect may be technically different, for example, from a Doppler smearing in a Doppler domain, which may be based on allocating a different phase to each pulse in a frame. For example, the range smearing effect may be complementary to the Doppler smearing.

In some demonstrative aspects, a radar device, e.g., as described above with reference to FIGS. 1-9, may be configured to implement one or more operations and/or functionalities of a transmission scheme, which may provide one or more technical advantages, for example, compared to a waveform diversity approach.

For example, a waveform diversity approach may be based, for example, on using different waveforms, and performing gain mitigation through a range profile stage. However, the waveform diversity approach may have limited applicability, for example, since apart from chirp up and chirp down, all other Linear Frequency Modulation (LFM) modifications may not be able to meet the same chirp duration and/or bandwidth. Accordingly, the waveform diversity approach may be limited to these two options, while other complementary methods may be required, for example, to support a large radio resources space, e.g., to accommodate a large number of vehicles in vicinity.

In some demonstrative aspects, a radar device, e.g., as described above with reference to FIGS. 1-9, may be configured to implement one or more operations and/or functionalities of a range smearing mechanism, which may be configured to provide a technical solution to reduce interference between radar radios transmitting according to a similar waveform design, for example, using a similar modulation and/or other attribute, e.g., as described below.

In some demonstrative aspects, a radar device, e.g., as described above with reference to FIGS. 1-9, may be configured to implement one or more operations and/or functionalities of a transmission mechanism, which may be configured to generate a difference, e.g., a relatively small difference, in a duration of radar frames transmitted from radar radios, e.g., as described below.

In some demonstrative aspects, a radar device, e.g., as described above with reference to FIGS. 1-9, may be configured to implement one or more operations and/or functionalities of a transmission mechanism, which may be configured to generate a difference, e.g., a relatively small difference, in a duration of a Pulse Repetition Interval (PRI) between radar signals transmitted from different radar radios, e.g., as described below.

For example, a first radar radio may be configured to transmit first radar signals according to a first PRI having a first PRI duration, and a second radar radio may be configured to transmit second radar signals according to a second PRI having a second PRI duration, which may be different from the first PRI duration. For example, a PRI difference, e.g., between the first PRI duration and the second PRI duration, may be relatively small.

In some demonstrative aspects, the PRI difference may be configured, e.g., as a small difference, which may be sufficient, for example, to cause an interpretation of an interference ghost to appear (to be “smeared”) over a plurality of different range bins, e.g., as described below.

In some demonstrative aspects, the PRI difference may be configured, for example, to cause an interpretation of the interference ghost to be smeared, for example, to appear in a plurality of different range bins, for example, in a different range bin for every pulse in a radar frame, e.g., as described below.

In some demonstrative aspects, a radar device, e.g., as described above with reference to FIGS. 1-9, may be configured to accumulate a range spectrum from all the received pulses (chirps), for example, to achieve a processing gain, which may be, for example, equal to a number of pulses in a radar frame, for example, during a range profile processing stage.

For example, in case a ghost appears, e.g., is smeared, over different range bins for the pulses of the radar frame, the accumulation impact of the ghost may be reduced, e.g., minimized. Accordingly, the PRI difference may result in a low processing gain, or even substantially no processing gain, being achieved for the ghosts caused by other radar devices, e.g., interferer radar devices.

In one example, the PRI difference may be implemented to provide a technical solution to support achieving a range processing gain factor of up to N or 10 log 10(N) dB, for example, for a frame including N chirps, e.g., as described below.

In one example, the PRI difference may be implemented to provide a technical solution to support achieving a range processing gain factor of up to 32 or 10 log 10(32)˜15 dB, for example, for a frame including 32 chirps.

In another example, the PRI difference may be implemented to provide a technical solution to support achieving a range processing gain factor of up to 64 or 10 log 10(64)˜18 dB, for example, for a frame including 64 chirps.

In another example, the PRI difference may be implemented to provide a technical solution to support achieving a range processing gain factor of up to 128 or 10 log 10(128)˜21 dB, for example, for a frame including 128 chirps.

In another example, the PRI difference may be implemented to provide a technical solution to support achieving a range processing gain factor of up to 256 or 10 log 10(256)˜24 dB, for example, for a frame including 256 chirps.

In another example, the PRI difference may be implemented to provide a technical solution to support achieving a range processing gain factor of up to 512 or 10 log 10(512)˜27 dB, for example, for a frame including 512 chirps.

In some demonstrative aspects, a radar device, e.g., as described above with reference to FIGS. 1-9, may be configured to implement one or more operations and/or functionalities of a transmission mechanism, which may be configured to implement PRI selected from a plurality of different PRIs. For example, different radar units utilizing the same radio resources may be configured to utilize different PRIs, e.g., as described below.

In some demonstrative aspects, a radar device, e.g., as described above with reference to FIGS. 1-9, may be configured to implement one or more operations and/or functionalities of a transmission mechanism, which may be configured to identify a particular Tx configuration having a particular PRI, e.g., as described below.

In some demonstrative aspects, the particular Tx configuration may be selected from a plurality of Tx configurations having a plurality of different PRIs, e.g., as described below.

In some demonstrative aspects, the radar device, e.g., as described above with reference to FIGS. 1-9, may be configured to implement one or more operations and/or functionalities of a transmission mechanism, which may be configured to generate Tx configuration information to configure transmission of a plurality of radar Tx pulses from the radar device according to the particular PRI, e.g., as described below.

In some demonstrative aspects, a radar device, e.g., as described above with reference to FIGS. 1-9, may be configured to implement one or more operations and/or functionalities of a transmission mechanism, which may be configured, for example, to determine a particular PRI to configure transmission of a plurality of radar Tx pulses from the radar device according to the particular PRI, e.g., as described below.

In some demonstrative aspects, a radar device, e.g., as described above with reference to FIGS. 1-9, may be configured to implement one or more operations and/or functionalities of a transmission mechanism, which may be configured, for example, to determine a plurality of different PRIs for a respective plurality of different radar devices, e.g., as described below.

In some demonstrative aspects, a PRI of the plurality of different PRIs, which may be allocated to a radar device from the plurality of different radar devices, may configure transmission of a plurality of radar Tx pulses from the radar device according to the PRI, e.g., as described below.

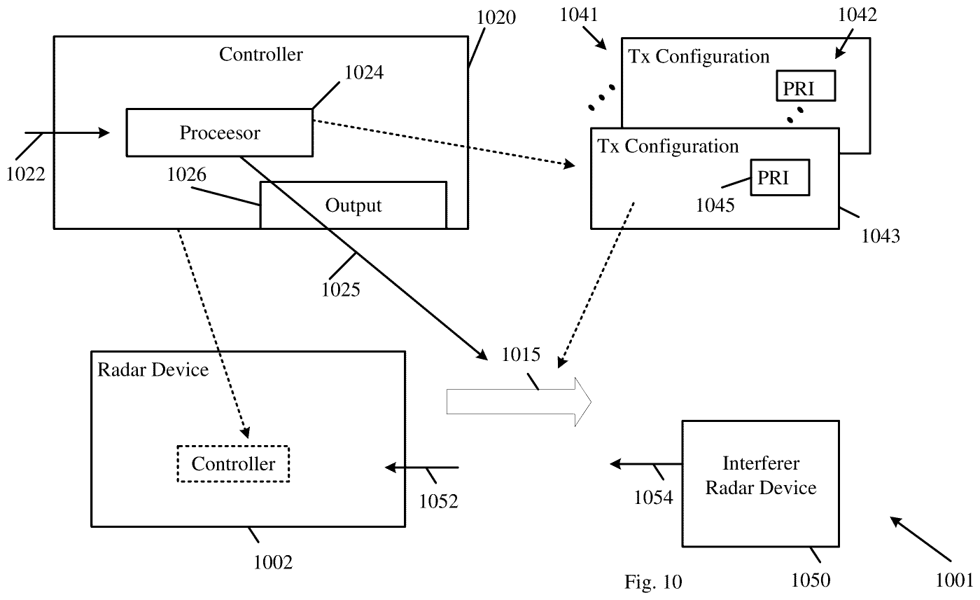

Reference is made to FIG. 10, which schematically illustrates a system 1001, in accordance with some demonstrative aspects.

In some demonstrative aspects, one or more elements of the system 1001 may be implemented by a radar device, e.g., radar device 800 (FIG. 8) and/or radar device 910 (FIG. 9), and/or a radar system, e.g., radar system 901 (FIG. 9).

In some demonstrative aspects, system 1001 may include a controller 1020, which may be configured to configure transmission of a plurality of radar Tx pulses 1015 from a radar device 1002, e.g., as described below.

In some demonstrative aspects, radar device 1002 may include a radar device of a vehicle. For example, radar device 1002 may include a radar device 910 (FIG. 9).

In other aspects, radar device 1002 may be included as part of, and/or implemented by, any other entity.

In some demonstrative aspects, one or more operations and/or functionalities of controller 1020 may be implemented, for example, as part of radar device 1002. For example, one or more operations and/or functionalities of controller 1020 may be implemented, for example, as part of baseband processor 930 (FIG. 9), and/or any other element of radar device 910 (FIG. 9).

In some demonstrative aspects, controller 1020 may be implemented, for example, as a separate element of, or as part of any other element of, system 1001.

For example, one or more operations and/or functionalities of controller 1020 may be implemented, for example, by a controller of a vehicle, e.g., vehicle 900 (FIG. 9).

In one example, one or more operations and/or functionalities of controller 1020 may be implemented, for example, by a system controller. For example, one or more operations and/or functionalities of controller 1020 may be implemented, for example, by radar system controller 950 (FIG. 9).

In another example, controller 1020 may be implemented, for example, a separate element of, or as part of any other element of, vehicle 900 (FIG. 9).

In some demonstrative aspects, controller 1020 may include a processor 1024, which may be configured to identify a particular Tx configuration 1043, e.g., as described below.

In some demonstrative aspects, processor 1024 may include, or may be implemented, partially or entirely, by circuitry and/or logic, e.g., one or more processors including circuitry and/or logic, memory circuitry and/or logic. Additionally or alternatively, one or more functionalities of processor 1024 may be implemented by logic, which may be executed by a machine and/or one or more processors, e.g., as described below.

In one example, processor 1024 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In some demonstrative aspects, processor 1024 may be configured to identify the particular Tx configuration 1045 selected from a plurality of Tx configurations 1041, e.g., as described below.

In some demonstrative aspects, the plurality of Tx configurations 1041 may have a plurality of different PRIs 1042, respectively, e.g., as described below.

In some demonstrative aspects, the particular Tx configuration 1043 may have a particular PRI 1045 from the plurality of different PRIs 1042, e.g., as described below.

In some demonstrative aspects, processor 1024 may be configured to generate Tx configuration information 1025, for example, to configure the transmission of the plurality of radar Tx pulses 1015 from the radar device 1002, for example, according to the particular PRI 1045 of the particular Tx configuration 1043, e.g., as described below.

In some demonstrative aspects, controller 1020 may include an output 1026, which may be configured, for example, to provide the Tx configuration information 1025, e.g., as described below.

In some demonstrative aspects, output 1026 may include any suitable output interface, output unit, output module, output component, output circuitry, memory interface, memory access unit, memory writer, digital memory unit, bus interface, processor interface, or the like, which may be capable of outputting the Tx configuration information 1025 to a memory, a processor, and/or any other suitable component to handle the Tx configuration information 1025.

In some demonstrative aspects, processor 1024 may be configured to process input information 1022, for example, to identify the particular Tx configuration 1043 selected from the plurality of Tx configurations 1041, e.g., as described below.

In some demonstrative aspects, processor 1024 may be configured to select the particular Tx configuration 1043 from the plurality of Tx configurations 1041, for example, based on a predefined criterion, e.g., as described below.

In some demonstrative aspects, the predefined criterion may be configured for detection of interferer radar Rx signals 1052 received at the radar device 1002, for example, from an interferer radar device 1050, e.g., as described below.

In other aspects, processor 1024 may be configured to select the particular Tx configuration 1043 from the plurality of Tx configurations 1041 based on any other suitable additional or alternative criterion.

In some demonstrative aspects, processor 1024 may be configured to randomly select the particular Tx configuration 1043 from the plurality of Tx configurations 1041, e.g., as described below.

In other aspects, processor 1024 may be configured to select or identify the particular Tx configuration 1043 from the plurality of Tx configurations 1041 based on any other additional and/or alternative mechanism and/or technique.

In some demonstrative aspects, the plurality of Tx configurations 1041 may have a same Tx waveform setting, e.g., as described below.

In some demonstrative aspects, the same Tx waveform setting may include a same modulation setting, e.g., as described below.

In some demonstrative aspects, the same Tx waveform setting may include a same number-of-pulses-per-frame setting, e.g., as described below.

In some demonstrative aspects, the same Tx waveform setting may include a same slope setting, e.g., as described below.

In some demonstrative aspects, the same Tx waveform setting may include a same frequency range setting, e.g., as described below.

In other aspects, the same Tx waveform setting may include any other additional and/or alternative waveform setting.

In some demonstrative aspects, the plurality of different PRIs 1042 may be configured, for example, such that interferer radar Rx signals 1052, e.g., when processed at the radar device 1002, for example, based on the particular PRI 1045, may result in smeared range information, which is smeared over a plurality of range bins, e.g., as described below.

In some demonstrative aspects, the interferer radar Rx signals 1052 may be based, for example, on interferer Tx pulses 1054, which may be, for example, according to another PRI, for example, different from the particular PRI 1045, e.g., as described below.

In some demonstrative aspects, the plurality of different PRIs 1042 may be configured, for example, based on a base PRI, denoted PRIbase, e.g., as described below.

For example, the base PRI may include a PRI, which may be utilized as a “basis” for defining additional PRIs, e.g., by applying a PRI adjustment, modification, change, variation, and/or shift, e.g., a Pri “delta”, relevant to the base PRI, e.g., as described below.

In some demonstrative aspects, the plurality of different PRIs 1042 may be configured, for example, based on a range-bin duration, denoted BINdur or TRB, corresponding to a range resolution, which may be based, for example, on the plurality of radar Tx pulses 1015, e.g., as described below.

In one example, the range-bin duration may include, may represent, and/or may be based on, a width of a range bin.

In one example, the range bin duration (in time) may be utilized, for example, in order to change the PRI by at least an order of a range bin duration, for example, in order to smear a ghost power far enough, e.g., to reduce, prevent and/or avoid coherent accumulation between pulses.

In some demonstrative aspects, the plurality of different PRIs 1042 may be configured, for example, based on a predefined time-base variance value, denoted offset or TBV, e.g., as described below.

In one example, the predefined time-base variance value may include, may represent, and/or may be based on, a time-difference jitter, e.g., an unknown time difference jitter. For example, the plurality of different PRIs 1042 may be configured to take this unknown “time difference jitter” into account.

In some demonstrative aspects, the plurality of different PRIs 1042 may include n different PRIs, e.g., e.g., as described below.

In some demonstrative aspects, an i-th PRI, denoted PRI(i), i=1 . . . n, of the plurality of n different PRIs 1042 may be configured, e.g., as follows:

$$PRI ( i ) = PRIbase + ai * offset + ai * bi * BINdur$$

wherein, ai denotes a first coefficient for the i-th PRI, wherein ai is 0, 1, or (−1), and bi denotes a second coefficient for the i-th PRI.

In one example, the offset may be positive (+offset), zero, or negative (−offset), e.g., in a worst case.

In some demonstrative aspects, the plurality of different PRIs 1042 may be configured, for example, such that a PRI difference between first and second consecutive PRIs of the plurality of different PRIs 1042 may be relatively small, e.g., negligible, for example, compared to a PRI length (total PRI length) of each of the first and second consecutive PRIs, e.g., as described below.

In one example, the plurality of different PRIs 1042 may be configured, for example, such that a PRI difference between each two consecutive PRIs of the of the plurality of different PRIs 1042 may be relatively small, e.g., negligible, for example, compared to the PRI length.

For example, a PRI may have a length in a range between 1 kilo (k) samples and 10 k samples.

According to this example, the PRI difference may be in a range, which may be relatively small compared to the PRI length, e.g., a PRI difference of less than 10 samples, for example, between 1-2 samples, or any other suitable number of samples.

In some demonstrative aspects, the plurality of different PRIs 1042 may be configured, for example, based on an integer multiple of the time-base variance value TBV (offset), e.g., 2*jitter clock, and one or more range bins, e.g., 1, 2, or 3 range bins.

In one example, the plurality of different PRIs 1042 may be configured, for example, such that a PRI may be defined based on addition of one or more range bins and the integer multiple of the time-base variance value TBV (offset) to the base PRI, e.g., +abs(offset)+(1, 2, 3)*range_bin.

In one example, the plurality of different PRIs 1042 may be configured, for example, such that a PRI may be defined based on subtraction of one or more range bins and the integer multiple of the time-base variance value TBV (offset) from the base PRI, e.g., −abs(offset)−(1, 2, 3)*range_bin.

In other aspects, the PRI difference may be defined based on any other additional and/or alternative attributes and/or parameters.

In some demonstrative aspects, the plurality of different PRIs 1042 may be configured to include at least four different PRIs, which may be utilized to support at least four respective Tx configurations, e.g., as described below.

In some demonstrative aspects, the plurality of different PRIs 1042 may be configured to include at least four different PRIs, which may be configured to support a technical solution to support at least four different radar devices, e.g., as described below.

In other aspects, the plurality of different PRIs 1042 may be configured to include any other suitable count of different PRIs, e.g., as described below.

In one example, the plurality of different PRIs 1042 may be configured to include at least four different PRIs, which may be defined, e.g., as follows:

$$\begin{matrix}PRI ( 1 ) = PRIbase + 2 * TBV + TRB \\ PRI ( 2 ) = PRIbase \\ PRI ( 3 ) = PRIbase - 2 * TBV - TRB \\ PRI ( 4 ) = PRIbase - 2 * TBV - 2 * TRB\end{matrix}$$

For example, the PRI duration may be in an order of O(1 k-10 k) samples, and the PRI difference between two consecutive PRIs, e.g., between PRI(1) and PRI(2), between PRI(2) and PRI(3), and/or between PRI(3) and PRI(4), may be, for example, in an order of 1[samples]/1[range bin]. According to this example, a ratio between the range-bin duration and the base PRI may be in the order of TRB/PRIbase=O(1/1000)−(1/10000), e.g., 1/300.

In another example, the plurality of different PRIs 1042 may be configured to include at least four different PRIs, which may be defined, e.g., as follows:

$$\begin{matrix}PRI ( 1 ) = PRIbase + 2 * TBV + 1.5 * TRB \\ PRI ( 2 ) = PRIbase + 2 * TBV + 0.5 * TRB \\ PRI ( 3 ) = PRIbase - 2 * TBV - 0.5 * TRB \\ PRI ( 4 ) = PRIbase - 2 * TBV - 1.5 * TRB\end{matrix}$$

According to this example, the PRI difference between two consecutive PRIs, e.g., between PRI(1) and PRI(2), between PRI(2) and PRI(3), and/or between PRI(3) and PRI(4), may be, for example, in an order of 1 TRB.

In another example, the plurality of different PRIs 1042 may be configured to include at least four different PRIs, which may be defined, e.g., as follows:

$$\begin{matrix}PRI ( 1 ) = PRIbase + TBV + 0.5 * TRB \\ PRI ( 2 ) = PRIbase - TBV - 0.5 * TRB\end{matrix}$$

For example, the PRI difference between two consecutive PRIs, e.g., between PRI(1) and PRI(2), between PRI(2) and PRI(3), and/or between PRI(3) and PRI(4), may be, for example, in an order of 1 TRB.

In other aspects, the plurality of different PRIs 1042 may be configured to include any other suitable count of different PRIs according to any other suitable additional or alternative PRI definition scheme.

In some demonstrative aspects, a PRI allocation mechanism utilizing the plurality of different PRIs 1042, e.g., as described above, may be implemented with respect to radar devices, which have a synchronization with respect to a frame start.

In some demonstrative aspects, a PRI allocation mechanism utilizing the plurality of different PRIs 1042, e.g., as described above, may be implemented with respect to radar devices, which do not have a synchronization with respect to frame start.

In some demonstrative aspects, the plurality of different PRIs 1042 may be configured, for example, according to a PRI coding scheme, which may be configured to provide a predefined range processing gain factor, e.g., as described below.

In some demonstrative aspects, the predefined range processing gain factor may be based, for example, on a ratio between a first range processing gain and a second range processing gain, e.g., as described below.

In some demonstrative aspects, the first range processing gain may be based, for example, on first radar Rx signals received at the radar device 1002, for example, based on the plurality of radar Tx pulses 1015, e.g., as described below.

In some demonstrative aspects, the second range processing gain may be based, for example, on second radar Rx signals, e.g., interferer radar Rx signals 1052, received at the radar device 1002, for example, based on interferer Tx pulses from an interferer radar device, for example, interferer Tx pulses 1054 from the interferer radar device 1050, e.g., as described below.

In some demonstrative aspects, the PRI coding scheme may be configured, for example, such that the second radar Rx signals, which are based on the interferer Tx pulses from the interferer radar device, when processed at the radar device 1002, may result in smeared range information, which is smeared over a plurality of range bins, e.g., as described below.

In some demonstrative aspects, a PRI difference between first and second consecutive PRIs of the plurality of different PRIs 1042 may be based, for example, on the predefined range processing gain factor, e.g., as described below.

In some demonstrative aspects, each PRI difference between each first and second consecutive PRIs of the plurality of different PRIs 1042 may be based, for example, on the predefined range processing gain factor, e.g., as described below.

In other aspects, only some of the PRI differences of the plurality of predefined PRIs 1042 may be based on the predefined range processing gain factor.

In some demonstrative aspects, the predefined range processing gain factor may be based, for example, on a count of radar Tx pulses 1015 per radar frame, e.g., as described below.

In some demonstrative aspects, the predefined range processing gain factor may be based, for example, on a ratio between the count of radar Tx pulses 1015 per radar frame, and a codebook factor, e.g., as described below.

In some demonstrative aspects, the codebook factor may be based, for example, on a ratio between a first PRI count and a second PRI count, e.g., as described below.

In some demonstrative aspects, the first PRI count may include a count of the plurality of different PRIs 1042, e.g., as described below.

In some demonstrative aspects, the second PRI count may include a count of possible different PRIs, for example, when a PRI difference between each two consecutive PRIs of the possible different PRIs is equal to a range-bin duration, e.g., as described below.

In some demonstrative aspects, the predefined range processing gain factor may be equal to 10 log 10(N) decibel (dB), wherein N denotes the count of radar Tx pulses 1015 per radar frame, for example, when a PRI difference between first and second consecutive PRIs of the plurality of different PRIs 1042 is equal to a range-bin duration, e.g., as described below.

In other aspects, the predefined range processing gain factor may be determined according to any other suitable definition and/or criteria.

In some demonstrative aspects, the predefined range processing gain factor may be at least 10 dB, e.g., as described below.

In some demonstrative aspects, the predefined range processing gain factor may be at least 15 dB, e.g., as described below.

In some demonstrative aspects, the predefined range processing gain factor may be at least 20 dB, e.g., as described below.

In other aspects, the predefined range processing gain factor may have any other value.

In some demonstrative aspects, the plurality different PRIs 1042 may be configured, for example, based on a range bin resolution to be implemented by radar device 1002, e.g., as described below.

For example, a “native” range bin (range resolution) for a radar device may be based on an RF bandwidth (BW) implemented by the radar device, e.g., as follows:

$$Range Resolution = \frac{c}{2 B} [ m ]$$

wherein B denotes the RF bandwidth in Hertz (Hz), and wherein c denotes the speed of light in meters per second (m/sec).

In one example, an RF BW of 250 MHz may lead to a range resolution, also referred to as “range bin width”, “range bin duration”, or “range bin size”). In another example, an RF BW of 1 Giga-Hertz (GHz) may lead to a range resolution of about 0.15 m.

For example, RF BWs of [125, 250, 500, 1000, 2000, 4000] MHz may typically be implemented for automotive radar. In some implementations, the RF BW may be limited to about 1 GHz, e.g., due to Homologation. Other RF BWs may also be implemented.

For example, a delay associated with the range may be based on a propagation velocity (delay) (speed of light in air/free space) e.g., as follows:

$${τ}_{d} = \frac{R}{c} [ sec ]$$

wherein τ_{d} denotes the propagation delay, and wherein R denotes the range.

For example, the range bin size may be expressed in terms of the propagation delay, e.g., as follows:

$${τ}_{Range Bin} = \frac{Range Resolution}{c} = \frac{1}{2 B} [ sec ]$$

For example, a radar implementation may use a window in the Fast-Time, for example, in order to reduce range sidelobes. However, such a window may enlarge a main lobe. Accordingly, an effective range resolution (range bin) may be degraded to be wider (longer) than the “Native” range bin. In one example, the effective range bin may be 1.2, 1.5, or even 2 times wider than the native range bin. It is noted that the native range bin size or the effective range bin size may be used as a base delta in the range smearing mechanisms described herein. In one example, using the native range bin size may degrade the gain, e.g., in a manner that may be window design dependent.

In some demonstrative aspects, the plurality of predefined PRIs 1042 may be configured, for example, based on a basic PRI codebook, e.g., as described below.

For example, the basic PRI codebook may be configured to include a plurality of possible different PRIs, which may be defined, for example, according to the time-base variance value TBV and the range bin duration, e.g., as described above.

For example, the basic PRI codebook may be configured to support a relatively high range processing gain factor (“gain factor”), e.g., a maximal gain factor.

For example, the gain factor may be based on a ratio between a processing gain of a desired reflected signal, e.g., of the victim or ego unit, and a processing gain of an interference signal.

For example, the gain factor may be based on a count of radar Tx pulses 1015 per radar frame.

For example, the basic PRI codebook may be configured to support a maximal gain factor, which may be based on a high, e.g., a maximal, range processing gain for the desired reflected signal, and a reduced, e.g., minimal, range processing gain for the interference signal.

For example, the high, e.g., maximal, range processing gain for the desired reflected signal may be achieved, for example, based on accumulation of power from all radar Tx pulses 1015 of the radar frame over the same range bin.

For example, the reduced, e.g., minimal, range processing gain for the interference signal may be achieved, for example, when there is no accumulation from the radar Tx pulses 1015 of the radar frame, e.g., when power of only one radar Tx pulse is processed for the range bin.

For example, the maximal gain factor may be determined, e.g., as follows:

$$\frac{Desired}{Interference} = \frac{N}{1} \to 10 log 10 ( N / 1 ) dB$$

wherein N denotes the count of the radar Tx pulses 1015 per radar frame.

In one example, the maximal gain factor may be determined for a radar frame including N=32 pulses (chirps), e.g., as follows:

$$\frac{Desired}{Interference} = \frac{N}{1} = 32 / 1 \to 10 log 10 ( N / 1 ) = 10 log 10 ( 32 ) = 15.05 dB$$

In another example, the maximal gain factor may be determined for a radar frame including N=64 pulses (chirps), e.g., as follows:

$$\frac{Desired}{Interference} = \frac{N}{1} = 64 / 1 \to 10 log 10 ( N / 1 ) = 10 log 10 ( 64 ) = 18.056 dB$$

In another example, the maximal gain factor may be determined for a radar frame including N=128 pulses (chirps), e.g., as follows:

$$\frac{Desired}{Interference} = \frac{N}{1} = 128 / 1 \to 10 log 10 ( N / 1 ) = 10 log 10 ( 128 ) = 21.07 dB$$

In another example, the maximal gain factor may be determined for a radar frame including N=256 pulses (chirps), e.g., as follows:

$$\frac{Desired}{Interference} = \frac{N}{1} = 256 / 1 \to 10 log 10 ( N / 1 ) = 10 log 10 ( 256 ) = 24.08 dB$$

In another example, the maximal gain factor may be determined for a radar frame including N=512 pulses (chirps), e.g., as follows:

$$\frac{Desired}{Interference} = \frac{N}{1} = 512 / 1 \to 10 log 10 ( N / 1 ) = 10 log 10 ( 512 ) = 27.09 dB$$

In some demonstrative aspects, the plurality of predefined PRIs 1042 may be configured according to a PRI codebook, which may be larger than the basic PRI codebook, e.g., as described below.

For example, an extended PRI codebook, e.g., larger than the basic Pri codebook, may be defined, for example, based on a tradeoff between the gain and the code book size.

For example, the basic PRI codebook may be extended by a factor of k>1, e.g., k=2, k=4, k=10, or any other value of k.

For example, the extended codebook may be k times larger than the basic PRI codebook, e.g., at the expense of a reduced gain.

For example, a gain factor corresponding to the extended PRI codebook may be determined, for example, based on the values of N and k, e.g., as follows:

$$\frac{Desired}{Interference} = \frac{N}{k} \to 10 log 10 ( N / k ) dB$$

For example, in case N=64 and k=10, e.g., the extended PRI codebook is 10 times larger than the basic PRI codebook, the gain factor of the extended PRI codebook may be determined, e.g., as follows:

$$\frac{Desired}{Interference} = \frac{N}{k} = \frac{64}{10} = 6.4 \to 10 log 10 ( N / k ) = 10 log 10 ( 64 / 10 ) = 8.06 dB$$

For example, in case N=128 and k=10, e.g., the extended PRI codebook is 10 times larger than the basic PRI codebook, the gain factor of the extended PRI codebook may be determined, e.g., as follows:

$$\frac{Desired}{Interference} = \frac{N}{k} = \frac{128}{10} = 12.8 \to 10 log 10 ( N / k ) = 10 log 10 ( 128 / 10 ) = 11.07 dB$$

For example, in case N=128 and k=4, e.g., the extended PRI codebook is 4 times larger than the basic PRI codebook, the gain factor of the extended PRI codebook may be determined, e.g., as follows:

$$\frac{Desired}{Interference} = \frac{N}{k} = \frac{128}{4} = 32 \to 10 log 10 ( N / k ) = 10 log 10 ( 128 / 4 ) = 15.05 dB$$

For example, in case N=512 and k=2, e.g., the extended PRI codebook is 2 times larger than the basic PRI codebook, the gain factor of the extended PRI codebook may be determined, e.g., as follows:

$$\frac{Desired}{Interference} = \frac{N}{k} = \frac{512}{2} = 256 \to 10 log 10 ( N / k ) = 10 log 10 ( 512 / 2 ) = 24.08 dB$$

It is noted that, although this gain factor of the extended PRI codebook is lower than the gain factor of the PRI codebook, the gain factor of the extended PRI codebook is still advantageous.

For example, when using a factor of k to enlarge the PRI codebook, the resulting PRI difference (“delta”) between different PRIs (codes) may be smaller than the range resolution (range bin), e.g., as follows:

$$Max gain code delta : {τ}_{d} \geq \frac{1}{2 B} [ sec ]$$

$$in this case the interference is lower by N$$

$$Reduced gain ( but k times larger code size ) delta : {τ}_{d} = \frac{1}{k} \frac{1}{2 B} [ sec ]$$

In some demonstrative aspects, during processing of radar data, for example, at a radar range profile stage (also referred to as the “fast time processing stage”), a correlation may be made between a transmitted radar pulse and a received radar pulse.

For example, this correlation may be performed for each pulse (chirp) in a frame.

In some demonstrative aspects, a coherent accumulation of an individual range profile outcome may be performed, for example, to achieve a processing gain.

For example, the processing gain may be substantially equal to the count of radar Tx pulses 1015 per the radar frame.

In some demonstrative aspects, processor 1024 may be configured to implement one or more operations and/or functionalities of a pulse-shifting mechanism, which may be configured to provide a technical solution to achieve the processing gain, for example, with respect to transmission of radar device 1002 (the “victim radar”), e.g., the radar's own transmissions.

In some demonstrative aspects, processor 1024 may be configured to provide a technical solution to reduce, e.g., substantially eliminating, the processing gain, for example, with respect to transmissions from other radar devices (the “interferer radar”).

In some demonstrative aspects, processor 1024 may be configured to reduce, e.g., substantially eliminate, the coherent accumulation resulting from a reflection of a signal transmitted by the interferer radar.

For example, the reflection of the signal transmitted by the interferer radar may illuminate a Field of View (FoV) of the victim radar.

For example, the interferer radar may have a substantially overlapping FoV with the FoV of the victim radar. For example, the interferer radar and the victim radar may be installed on the same vehicle, or they may be installed on different vehicles.

In some demonstrative aspects, the ability to achieve the processing gain with respect the transmission of the victim radar, while reducing, e.g., substantially eliminating, the processing gain with respect to the interferer radar, may be implemented to provide a technical solution to achieve a power, a gain advantage (“a gain difference”), e.g., in the form of a predefined range processing gain factor, of the victim radar detections, e.g., versus ghosts originating from a different radar, e.g., the interferer radar.

In some demonstrative aspects, this gain difference may be based on, e.g., may be substantially equal to, the length of the radar frame, e.g., based on the number of pulses 1015 in the radar frame.

For example, in case of N pulses per radar frame, the predefined range processing gain factor may be based on a factor of N.

In one example, in case of 128 pulses per radar frame, the predefined range processing gain factor may be based on a factor of 128, e.g., 21 dB.

In another example, in case of 256 pulses per radar frame, the predefined range processing gain factor may be based on a factor of 256, e.g., 24 dB.

In some demonstrative aspects, controller 1020 may be configured to provide the Tx configuration information 1025, for example, to configure a number of samples per radar Tx pulse 1015, e.g., as described below.

In some demonstrative aspects, controller 1020 may be configured to provide the Tx configuration information 1025, for example, to configure the number of samples per radar Tx pulse 1015, for example, to generate the plurality of radar Tx pulses 1015, for example, based on the particular PRI 1045 of the particular Tx configuration 1043, e.g., as described below.

In some demonstrative aspects, controller 1020 may be configured to provide the Tx configuration information 1025, for example, to configure a sampling rate, e.g., as described below.

In some demonstrative aspects, the Tx configuration information 1025 may configure the sampling rate, for example, to generate the plurality of radar Tx pulses 1015, for example, based on the particular PRI 1045 of the particular Tx configuration 1043, e.g., as described below.

In some demonstrative aspects, controller 1020 may be configured to provide the Tx configuration information 1025, for example, to configure a pulse length, e.g., as described below.

In some demonstrative aspects, the Tx configuration information 1025 may configure the pulse length, for example, to generate the plurality of radar Tx pulses 1015, for example, based on the particular PRI 1045 of the particular Tx configuration 1043, e.g., as described below.

In other aspects, the Tx configuration information 1025 may configure any other additional and/or alternative parameter and/or attribute of the plurality of radar Tx pulses 1015.

In some demonstrative aspects, processor 1024 may be configured to generate first Tx configuration information 1025 to configure transmission of a first plurality of radar Tx pulses 1015 from the radar device 1002, for example, according to a first particular PRI of a first particular Tx configuration selected from the plurality of Tx configurations 1041, e.g., as described below.

In some demonstrative aspects, processor 1024 may be configured to generate second Tx configuration information 1025 to configure transmission of a second plurality of radar Tx pulses 1015 from the radar device 1002, for example, according to a second particular PRI of a second particular Tx configuration selected from the plurality of Tx configurations 1041, e.g., as described below.

In some demonstrative aspects, the first plurality of radar Tx pulses 1015 may be in a first radar frame, e.g., as described below.

In some demonstrative aspects, the second plurality of radar Tx pulses 1015 may be in a second radar frame, e.g., as described below.

In some demonstrative aspects, processor 1024 may be configured to generate first frame Tx configuration information 1025 to configure transmission of the first radar frame, e.g., as described below.

In some demonstrative aspects, processor 1024 may be configured to generate second frame Tx configuration information to configure transmission of the second radar frame, for example, subsequent to the first radar frame, e.g., as described below.

In some demonstrative aspects, the first frame Tx configuration information may include the first Tx configuration information 1025 to configure transmission of the first plurality of radar Tx pulses 1015, e.g., as described below.

In some demonstrative aspects, the second frame Tx configuration information may include the second Tx configuration information 1025 to configure transmission of the second plurality of radar Tx pulses 1015, e.g., as described below.

In some demonstrative aspects, the first plurality of radar Tx pulses 1015 and the second plurality of radar Tx pulses 1015 may be in a same radar frame, e.g., as described below.

In some demonstrative aspects, processor 1024 may be configured to generate first frame Tx configuration information to configure transmission of a first radar frame, e.g., as described below.

In some demonstrative aspects, processor 1024 may be configured to generate second frame Tx configuration information to configure transmission of a second radar frame, for example, subsequent to the first radar frame, e.g., as described below.

In some demonstrative aspects, processor 1024 may be configured to generate the first frame Tx configuration information and the second frame Tx configuration information, for example, according to a first Tx scheme, e.g., as described below.

In some demonstrative aspects, processor 1024 may be configured to generate the first frame Tx configuration information according to the first Tx scheme, for example, by generating the first frame Tx configuration information to include the first Tx configuration information 1025, for example, to configure transmission of the first plurality of radar Tx pulses 1015, for example, followed by the second Tx configuration information 1025 to configure transmission of the second plurality of radar Tx pulses 1015.

In some demonstrative aspects, processor 1024 may be configured to generate the second frame Tx configuration information according to the first Tx scheme, for example, by generating the second frame Tx configuration information to include the first Tx configuration information 1025, for example, to configure transmission of the first plurality of radar Tx pulses 1015, for example, followed by the second Tx configuration information 1025 to configure transmission of the second plurality of radar Tx pulses 1015.

In some demonstrative aspects, processor 1024 may be configured to generate the first frame Tx configuration information and the second frame Tx configuration information, for example, according to a second Tx scheme, e.g., as described below.

In some demonstrative aspects, processor 1024 may be configured to generate the first frame Tx configuration information according to the second Tx scheme, for example, by generating the first frame Tx configuration information to include the first Tx configuration information 1025 to configure transmission of the first plurality of radar Tx pulses 1015, for example, followed by the second Tx configuration information 1025 to configure transmission of the second plurality of radar Tx pulses 1015.

In some demonstrative aspects, processor 1024 may be configured to generate the second frame Tx configuration information according to the second Tx scheme, for example, by generating the second frame Tx configuration information to include third Tx configuration information 1025 to configure transmission of a third plurality of radar Tx pulses 1015 according to a third particular PRI of a third particular Tx configuration selected from the plurality of Tx configurations 1041, for example, followed by fourth Tx configuration information 1025 to configure transmission of a fourth plurality of radar Tx pulses 1015 according to a fourth particular PRI of a fourth particular Tx configuration selected from the plurality of Tx configurations 1041.

In some demonstrative aspects, processor 1024 may be configured to generate the first frame Tx configuration information and the second frame Tx configuration information, for example, according to a second Tx scheme, e.g., as described below.

In some demonstrative aspects, processor 1024 may be configured to generate the first frame Tx configuration information according to the third Tx scheme, for example, by generating the first frame Tx configuration information to include the first Tx configuration information 1025 to configure transmission of the first plurality of radar Tx pulses 1015, for example, followed by the second Tx configuration information 1025 to configure transmission of the second plurality of radar Tx pulses 1015.

In some demonstrative aspects, processor 1024 may be configured to generate the second frame Tx configuration information according to the third Tx scheme, for example, by generating the second frame Tx configuration information to include the second Tx configuration information 1025 to configure transmission of the second plurality of radar Tx pulses 1015, for example, followed by the first Tx configuration information 1025 to configure transmission of the first plurality of radar Tx pulses 1015, for example, according to a third Tx scheme, e.g., as described below.

In other aspects, processor 1024 may be configured to generate the first frame Tx configuration information and the second frame Tx configuration information, for example, according to any other suitable Tx scheme.

In some demonstrative aspects, the plurality of different PRIs 1042 may be configured, for example, such that a PRI difference between first and second consecutive PRIs of the plurality of different PRIs 1042 may be based, for example, on a range-bin duration corresponding to a range resolution, for example, based on the plurality of radar Tx pulses 1015, e.g., as described below.

In some demonstrative aspects, the plurality of different PRIs 1042 may be configured, for example, such that each PRI difference between each first and second consecutive PRIs of the plurality of different PRIs 1042 may be based, for example, on the range-bin duration corresponding to the range resolution, for example, based on the plurality of radar Tx pulses 1015, e.g., as described below.

In some demonstrative aspects, the plurality of different PRIs 1042 may be configured, for example, such that the PRI difference between first and second consecutive PRIs of the plurality of different PRIs 1042 may be equal to or longer than 5 percent of the range-bin duration corresponding to the range resolution, for example, based on the plurality of radar Tx pulses 1015, e.g., as described below.

In some demonstrative aspects, the plurality of different PRIs 1042 may be configured, for example, such that each PRI difference between each first and second consecutive PRIs of the plurality of different PRIs 1042 may be equal to or longer than 5 percent of the range-bin duration corresponding to the range resolution, for example, based on the plurality of radar Tx pulses 1015, e.g., as described below.

In some demonstrative aspects, the plurality of different PRIs 1042 may be configured, for example, such that the PRI difference between first and second consecutive PRIs of the plurality of different PRIs 1042 may be equal to or longer than 10 percent of the range-bin duration corresponding to the range resolution, for example, based on the plurality of radar Tx pulses 1015, e.g., as described below.

In some demonstrative aspects, the plurality of different PRIs 1042 may be configured, for example, such that each PRI difference between each first and second consecutive PRIs of the plurality of different PRIs 1042 may be equal to or longer than 10 percent of the range-bin duration corresponding to the range resolution, for example, based on the plurality of radar Tx pulses 1015, e.g., as described below.

In some demonstrative aspects, the plurality of different PRIs 1042 may be configured, for example, such that the PRI difference between first and second consecutive PRIs of the plurality of different PRIs 1042 may be equal to or longer than 25 percent of the range-bin duration corresponding to the range resolution, for example, based on the plurality of radar Tx pulses 1015, e.g., as described below.

In some demonstrative aspects, the plurality of different PRIs 1042 may be configured, for example, such that each PRI difference between each first and second consecutive PRIs of the plurality of different PRIs 1042 may be equal to or longer than 25 percent of the range-bin duration corresponding to the range resolution, for example, based on the plurality of radar Tx pulses 1015, e.g., as described below.

In some demonstrative aspects, the plurality of different PRIs 1042 may be configured, for example, such that the PRI difference between first and second consecutive PRIs of the plurality of different PRIs 1042 may be equal to or longer than 35 percent of the range-bin duration corresponding to the range resolution, for example, based on the plurality of radar Tx pulses 1015, e.g., as described below.

In some demonstrative aspects, the plurality of different PRIs 1042 may be configured, for example, such that each PRI difference between each first and second consecutive PRIs of the plurality of different PRIs 1042 may be equal to or longer than 35 percent of the range-bin duration corresponding to the range resolution, for example, based on the plurality of radar Tx pulses 1015, e.g., as described below.

In some demonstrative aspects, the plurality of different PRIs 1042 may be configured, for example, such that the PRI difference between first and second consecutive PRIs of the plurality of different PRIs 1042 may be equal to or longer than 50 percent of the range-bin duration corresponding to the range resolution, for example, based on the plurality of radar Tx pulses 1015, e.g., as described below.

In some demonstrative aspects, the plurality of different PRIs 1042 may be configured, for example, such that each PRI difference between each first and second consecutive PRIs of the plurality of different PRIs 1042 may be equal to or longer than 50 percent of the range-bin duration corresponding to the range resolution, for example, based on the plurality of radar Tx pulses 1015, e.g., as described below.

In some demonstrative aspects, the plurality of different PRIs 1042 may be configured, for example, such that the PRI difference between first and second consecutive PRIs of the plurality of different PRIs 1042 may be equal to or longer than the range-bin duration corresponding to the range resolution, for example, based on the plurality of radar Tx pulses 1015, e.g., as described below.

In some demonstrative aspects, the plurality of different PRIs 1042 may be configured, for example, such that each PRI difference between each first and second consecutive PRIs of the plurality of different PRIs 1042 may be equal to or longer than the range-bin duration corresponding to the range resolution, for example, based on the plurality of radar Tx pulses 1015, e.g., as described below.

In some demonstrative aspects, the plurality of different PRIs 1042 may be configured, for example, such that the PRI difference between first and second consecutive PRIs of the plurality of different PRIs 1042 may be equal to or longer than 1/10,000 of each of the first and second consecutive PRIs, e.g., as described below.

In some demonstrative aspects, the plurality of different PRIs 1042 may be configured, for example, such that each PRI difference between each first and second consecutive PRIs of the plurality of different PRIs 1042 may be equal to or longer than 1/10,000 of each of the first and second consecutive PRIs, e.g., as described below.

In some demonstrative aspects, the plurality of different PRIs 1042 may be configured, for example, such that the PRI difference between first and second consecutive PRIs of the plurality of different PRIs 1042 may be equal to or shorter than ten times the range-bin duration corresponding to the range resolution, for example, based on the plurality of radar Tx pulses 1015, e.g., as described below.

In some demonstrative aspects, the plurality of different PRIs 1042 may be configured, for example, such that each PRI difference between each first and second consecutive PRIs of the plurality of different PRIs 1042 may be equal to or shorter than ten times the range-bin duration corresponding to the range resolution, for example, based on the plurality of radar Tx pulses 1015, e.g., as described below.

In some demonstrative aspects, the plurality of different PRIs 1042 may be configured, for example, such that the PRI difference between first and second consecutive PRIs of the plurality of different PRIs 1042 may be equal to or shorter than five times the range-bin duration corresponding to the range resolution, for example, based on the plurality of radar Tx pulses 1015, e.g., as described below.

In some demonstrative aspects, the plurality of different PRIs 1042 may be configured, for example, such that each PRI difference between each first and second consecutive PRIs of the plurality of different PRIs 1042 may be equal to or shorter than five times the range-bin duration corresponding to the range resolution, for example, based on the plurality of radar Tx pulses 1015, e.g., as described below.

In some demonstrative aspects, the plurality of different PRIs 1042 may be configured, for example, such that the PRI difference between first and second consecutive PRIs of the plurality of different PRIs 1042 may be shorter than a duration of 10 samples according to a sampling rate, for example, to generate the plurality of radar Tx pulses 1015, e.g., as described below.

In some demonstrative aspects, the plurality of different PRIs 1042 may be configured, for example, such that each PRI difference between each first and second consecutive PRIs of the plurality of different PRIs 1042 may be shorter than the duration of 10 samples according to the sampling rate, for example, to generate the plurality of radar Tx pulses 1015, e.g., as described below.

In some demonstrative aspects, the plurality of different PRIs 1042 may be configured, for example, such that the PRI difference between first and second consecutive PRIs of the plurality of different PRIs 1042 may be shorter than a duration of 5 samples according to the sampling rate, for example, to generate the plurality of radar Tx pulses 1015, e.g., as described below.

In some demonstrative aspects, the plurality of different PRIs 1042 may be configured, for example, such that each PRI difference between each first and second consecutive PRIs of the plurality of different PRIs 1042 may be shorter than the duration of 5 samples according to the sampling rate, for example, to generate the plurality of radar Tx pulses 1015, e.g., as described below.

In some demonstrative aspects, the plurality of different PRIs 1042 may be configured, for example, such that the PRI difference between first and second consecutive PRIs of the plurality of different PRIs 1042 may be shorter than a duration of 3 samples according to the sampling rate, for example, to generate the plurality of radar Tx pulses 1015, e.g., as described below.

In some demonstrative aspects, the plurality of different PRIs 1042 may be configured, for example, such that each PRI difference between each first and second consecutive PRIs of the plurality of different PRIs 1042 may be shorter than the duration of 3 samples according to the sampling rate, for example, to generate the plurality of radar Tx pulses 1015, e.g., as described below.

In some demonstrative aspects, the plurality of different PRIs 1042 may be configured, for example, such that the PRI difference between first and second consecutive PRIs of the plurality of different PRIs 1042 may be shorter than a duration of 2 samples according to the sampling rate, for example, to generate the plurality of radar Tx pulses 1015, e.g., as described below.

In some demonstrative aspects, the plurality of different PRIs 1042 may be configured, for example, such that each PRI difference between each first and second consecutive PRIs of the plurality of different PRIs 1042 may be shorter than the duration of 2 samples according to the sampling rate, for example, to generate the plurality of radar Tx pulses 1015, e.g., as described below.

In some demonstrative aspects, the plurality of different PRIs 1042 may be configured, for example, such that the PRI difference between first and second consecutive PRIs of the plurality of different PRIs 1042 may be shorter than a duration of one sample according to the sampling rate, for example, to generate the plurality of radar Tx pulses 1015, e.g., as described below.

In some demonstrative aspects, the plurality of different PRIs 1042 may be configured, for example, such that each PRI difference between each first and second consecutive PRIs of the plurality of different PRIs 1042 may be shorter than the duration of one sample according to the sampling rate, for example, to generate the plurality of radar Tx pulses 1015, e.g., as described below.

In other aspects, the plurality of different PRIs 1042 may be configured, for example, such that there may be any other suitable PRI difference between first and second consecutive PRIs of the plurality of different PRIs 1042.

In some demonstrative aspects, processor 1024 may be configured to set, configure, adjust, change, and/or modify one or more PRIs of the plurality of different PRIs 1042, for example, some or all of the plurality of different PRIs 1042, e.g., the PRI 1045, for example, by one or more radar transmission techniques, e.g., as described below.

In some demonstrative aspects, processor 1024 may be configured to set, configure, adjust, change, and/or modify one or more PRIs of the plurality of different PRIs 1042, for example, some or all of the plurality of different PRIs 1042, e.g., the PRI 1045, for example, by configuring, setting, adjusting, changing and/or modifying, one or more parameters and/or attributes, which may affect the PRI, e.g., as described below.

In some demonstrative aspects, processor 1024 may be configured to set, configure, adjust, change, and/or modify one or more PRIs of the plurality of different PRIs 1042, for example, some or all of the plurality of different PRIs 1042, e.g., the PRI 1045, for example, by configuring, setting, adjusting, changing and/or modifying a time base, e.g., the base PRI PRIbase, that measures the PRI. For example, different radar devices may be configured to use different PRIs from the plurality of different PRIs 1042, for example, by configuring the time base that measures the PRI.

In one example, processor 1024 may be configured to set, configure, adjust, change, and/or modify one or more PRIs of the plurality of different PRIs 1042, for example, some or all of the plurality of different PRIs 1042, e.g., the PRI 1045, for example, by configuring, setting, adjusting, changing and/or modifying a duration of a saw tooth waveform, for example, in a Voltage Controlled Oscillator (VCO) based transmitter, for example, to modify the time base for a PRI.

In another example, processor 1024 may be configured to set, configure, adjust, change, and/or modify one or more PRIs of the plurality of different PRIs 1042, for example, some or all of the plurality of different PRIs 1042, e.g., the PRI 1045, for example, by configuring, setting, adjusting, changing and/or modifying a sampling rate, for example, in a digital up-conversion system, for example, to modify the time base for a PRI.

In some demonstrative aspects, processor 1024 may be configured to set, configure, adjust, change, and/or modify one or more PRIs of the plurality of different PRIs 1042, for example, some or all of the plurality of different PRIs 1042, e.g., the PRI 1045, for example, by configuring, setting, adjusting, changing and/or modifying a length of a PRI, e.g., such that different radar devices may use different PRIs.

In other aspects, any other additional or alternative parameter and/or attribute may be utilized to support a different time base for configuring, setting, adjusting, changing and/or modifying the PRI.

In some demonstrative aspects, processor 1024 may be configured to determine a plurality of particular Tx configurations 1043 to be simultaneously implemented by a plurality of radar devices 1002, which may be co-located in a vehicle, e.g., as described below.

In one example, processor 1024 may be configured to determine the plurality of particular Tx configurations 1043 to be simultaneously implemented by the plurality of radar devices 910 (FIG. 9), which may be co-located in vehicle 900 (FIG. 9).

In some demonstrative aspects, the plurality of particular Tx configurations 1043 may include a first Tx configuration 1043 and a second Tx configuration 1043, which may be, for example, selected from the plurality of Tx configurations 1041, e.g., as described below.

In some demonstrative aspects, the first Tx configuration 1043 may have a first PRI, e.g., as described below.

In some demonstrative aspects, the second Tx configuration 1043 may have a second PRI, which may be different from the first PRI, e.g., as described below.

For example, processor 1024 may be configured to determine a first particular Tx configuration having a first PRI for radar device 904 (FIG. 9); a second particular Tx configuration having a second PRI for radar device 902 (FIG. 9); a third particular Tx configuration having a third PRI for radar device 912 (FIG. 9); a fourth particular Tx configuration having a fourth PRI for radar device 916 (FIG. 9); and/or a fifth particular Tx configurations having a fifth PRI for radar device 918 (FIG. 9).

In one example, the first, second, third, fourth, and/or fifth particular Tx configurations may be simultaneously implemented by the first, second, third, fourth, and/or fifth radar devices 910 (FIG. 9), respectively.

In one example, at least two PRIs of the first, second, third, fourth, and fifth PRIs may be different from one another.

In one example, all of the first, second, third, fourth and fifth PRIs may be different from one another.

In another example, only some of the first, second, third, fourth and fifth PRIs may be different from one another.

For example, the first and second PRIs may be the same, for example, in case the first and second PRIs are to be implemented by first and second radar devices 910, which are not expected to interfere with each other. For example, the first radar device 910 may have a first FoV, and the second radar device 910 may have a second FoV, which may have substantially no overlap with the first FoV.

For example, and third PRI may be different from the first and second PRIs, for example, in case the third PRI is to be implemented by a third radar device 910, which is expected to interfere with the first and second radar devices 910. For example, the third radar device 910 may have a third FoV, which may at least partially overlap with the first FoV and/or the second FoV.

In some demonstrative aspects, processor 1024 may be configured to implement one or more operations and/or functionalities of a Tx configuration mechanism, which may be implemented to allocate to a plurality of co-located radar devices a plurality Tx configurations, which may have a similar waveform and a PRI difference of one or more, e.g., few, range bins, for example, to provide a technical solution to reduce interference between the co-located radar devices.

In some demonstrative aspects, the plurality Tx configurations having the similar waveform may include Tx configurations utilizing a waveform having a same modulation, e.g., a similar LFM modulation, and/or any other type of modulation.

For example, the plurality Tx configurations having the similar waveform may include Tx configurations utilizing a waveform having a same number of pulses per frame, a same ramp slope, e.g., in LFM, and/or a same low and/or high frequency of the LFM.

In some demonstrative aspects, the plurality of PRIs implemented by the plurality of Tx configurations may be configured according to a PRI difference of one or more range bins, e.g., a few range bins, e.g., as described above.

In some demonstrative aspects, a PRI difference of one or more range bins, e.g., a few range bins, may be generated, for example, using a different number of samples, e.g., as described above.

In some demonstrative aspects, a PRI difference of one or more, e.g., few range bins, may be generated, for example, using a different value of a sampling clock, e.g., as described above.

In some demonstrative aspects, processor 1024 may be configured to implement a constat PRI for transmission of the radar Tx pulses 1015.

In one example, processor 1024 may be configured to implement the constat PRI for transmission of all radar Tx pulses 1015.

In another example, processor 1024 may be configured to implement the constat PRI for transmission of some radar Tx pulses 1015.

In some demonstrative aspects, processor 1024 may be configured to implement a variable PRI for transmission of the radar Tx pulses 1015.

In one example, processor 1024 may be configured to change the PRI in a radar frame. For example, processor 1024 may be configured to use a first constat PRI for transmission of some radar Tx pulses 1015 belonging to a same radar frame, and to use a second PRI for transmission of other radar Tx pulses 1015 belonging to the same radar frame. In one example, processor 1024 may be configured to change the PRI for every pulse in the radar frame.

In another example, processor 1024 may be configured to implement a same PRI for transmission of all radar Tx pulses 1015 belonging to a same radar frame, or to two or more radar frames. For example, processor 1024 may be configured to change the PRI every radar frame.

For example, processor 1024 may be configured to implement the variable PRI, for example, as long as a processing gain between radar devices remains low.

In some demonstrative aspects, processor 1024 may be configured to randomly select from the plurality of different PRIs 1042 the particular PRI to be implemented for the transmission of the radar Tx pulses 1015.

In other aspects, processor 1024 may be configured to select the particular PRI from the plurality of different PRIs 1042 according to any other suitable selection mechanism and/or criteria.

In some demonstrative aspects, radar device 1002 may be assigned with the Tx configuration 1043, for example, from a local controller, e.g., controller 1020.

In some demonstrative aspects, radar device 1002 may be assigned with the Tx configuration 1043, e.g., from higher layers, for example, through an API.

In some demonstrative aspects, processor 1024 may be configured to implement one or more operations and/or functionalities of a temporal filtering mechanism, for example, to identify a range smearing phenomena, e.g., based on Rx signals from an interferer radar device.

In some demonstrative aspects, processor 1024 may be configured to assign the Rx signals resulting in the range smearing phenomena to an interfere radar, e.g., a co-located radar.

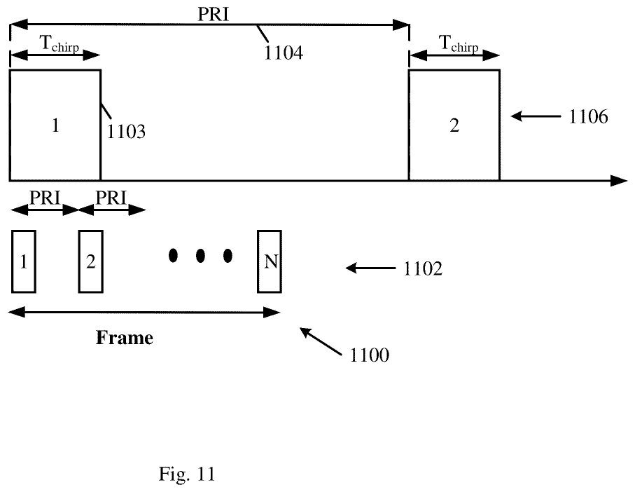

Reference is made to FIG. 11, which schematically illustrates a radar frame 1100, in accordance with some demonstrative aspects.

In some demonstrative aspects, as shown in FIG. 11, radar frame 1100 may include a plurality of radar Tx pulses 1102. For example, radar frame 1100 may include N radar Tx pulses 1102.

In some demonstrative aspects, a Tx pulse 1102 (also referred to as a “Chirp”) may include a brief burst, which may be transmitted by a radar device, e.g., radar device 1002 (FIG. 10).

In some demonstrative aspects, as shown in FIG. 11, a radar Tx pulse 1103 may have a chirp length, denoted T_{chirp}.

For example, the chirp length T_{chirp} may be related, e.g., inversely related, to a maximum unambiguous range of the radar device. For example, a chirp length may support maximum unambiguous range, and a second chirp length, which is shorter than the first chirp length, may support a higher maximum unambiguous range.

In some demonstrative aspects, as shown in FIG. 11, a PRI 1104 may include a time interval between consecutive radar pulses 1106.

In some demonstrative aspects, the PRI 1104 may determine a rate of pulse transmission.

For example, the PRI 1104 may be related, e.g., inversely related, to a maximum unambiguous velocity of the radar device. For example, a first PRI may support maximum unambiguous velocity, and a second PRI, which is shorter than the first PRI, may support a higher maximum unambiguous velocity.

In some demonstrative aspects, a processor, e.g., processor 1024 (FIG. 10), may be configured to generate the Tx configuration information 1025 (FIG. 10), for example, to configure transmission of the plurality of radar Tx pulses 1102, for example, according to a particular PRI 1104 selected from a plurality of different PRIs, e.g., the plurality of different PRIs 1042 (FIG. 10).

In some demonstrative aspects, the processor, e.g., processor 1024 (FIG. 10), may be configured to generate Tx configuration information 1025 (FIG. 10), for example, to configure transmission of a first plurality of radar Tx pulses 1102, e.g., a Tx pulses (1, 2, . . . , a), for example, according to a first particular PRI 1104.

In some demonstrative aspects, the processor, e.g., processor 1024 (FIG. 10), may be configured to generate Tx configuration information 1025 (FIG. 10), for example, to configure transmission of a second plurality of radar Tx pulses 1102, e.g., b Tx pulses (a+1, a+2, . . . , a+b), for example, according to a second particular PRI 1104, which is different from the first particular PRI 1104.

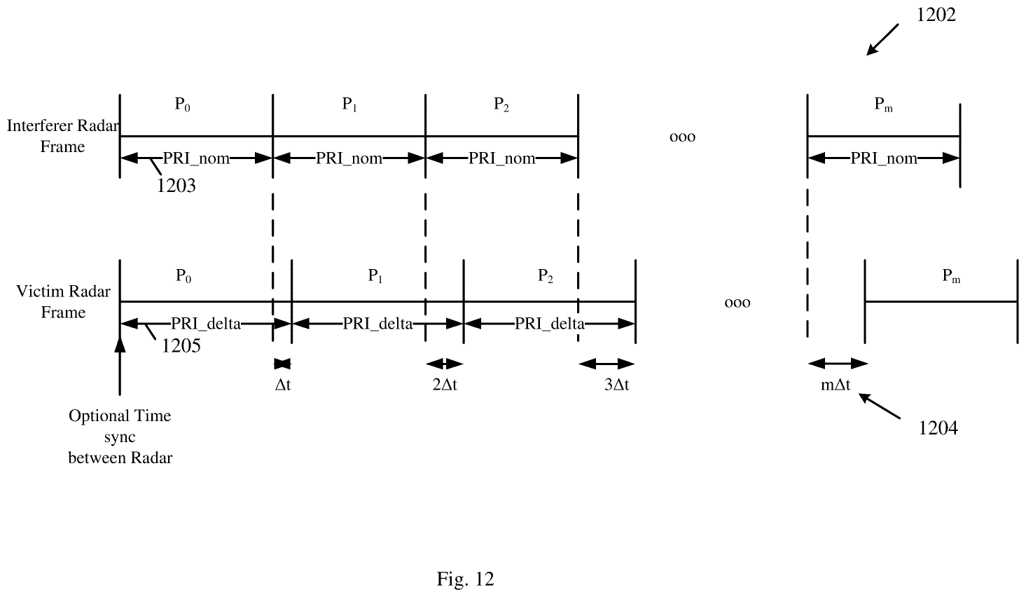

Reference is made to FIG. 12, which schematically illustrates a first radar frame 1202 having a first PRI 1203, and a second radar frame 1204 having a second PRI 1205, in accordance with some demonstrative aspects.

In some demonstrative aspects, as shown in FIG. 12, the second PRI 1205 may be different from the first PRI 1203. For example, as shown in FIG. 12, the second PRI 1205 may be longer than the first PRI 1203.

In some demonstrative aspects, as shown in FIG. 12, there may be a PRI difference of Δt between the second PRI 1205 and the first PRI 1203.

In some demonstrative aspects, the first PRI 1203 may be implemented by a first radar device, and the second PRI 1205 may be implemented by a second radar device.

In some demonstrative aspects, the first and second radar devices may be implemented separately and/or independently, e.g., by first and second respective vehicles.

For example, a processor, e.g., processor 1024 (FIG. 10), of the first vehicle may be configured to determine the first PRI 1203 to be implemented by the first radar device of the first vehicle for transmission of a plurality of radar Tx pulses, e.g., the plurality of radar Tx pulses 1015 (FIG. 1).

For example, a processor, e.g., processor 1024 (FIG. 10), of the second vehicle may be configured to determine the second PRI 1205 to be implemented by the second radar device of the second vehicle for transmission of a plurality of radar Tx pulses, e.g., the plurality of radar Tx pulses 1015 (FIG. 1).

In some demonstrative aspects, the first and second radar devices may be co-located at a same vehicle.

For example, a processor, e.g., processor 1024 (FIG. 10), may be configured to determine the first PRI 1203 and the second PRI 1205 to be simultaneously implemented by the first radar device and the second radar device, respectively, which may be co-located in a same vehicle or any other entity.

In some demonstrative aspects, the PRI difference, e.g., the PRI difference Δt, between the second PRI 1205 and the first PRI 1203 may be implemented to provide a technical solution to prevent and/or mitigate interference at a radar device (“victim radar device”), e.g., the second radar device, which may be caused by the radar transmissions from another radar device (“interferer radar device”), e.g., the first radar device, or vice versa, e.g., as described below.

In some demonstrative aspects, the PRI difference, e.g., the PRI difference Δt, between the second PRI 1205 and the first PRI 1203 may be implemented to provide a technical solution to cause the radar transmissions from the interferer radar device to be smeared in a range domain, for example, when processed at the victim radar device, e.g., as described below.

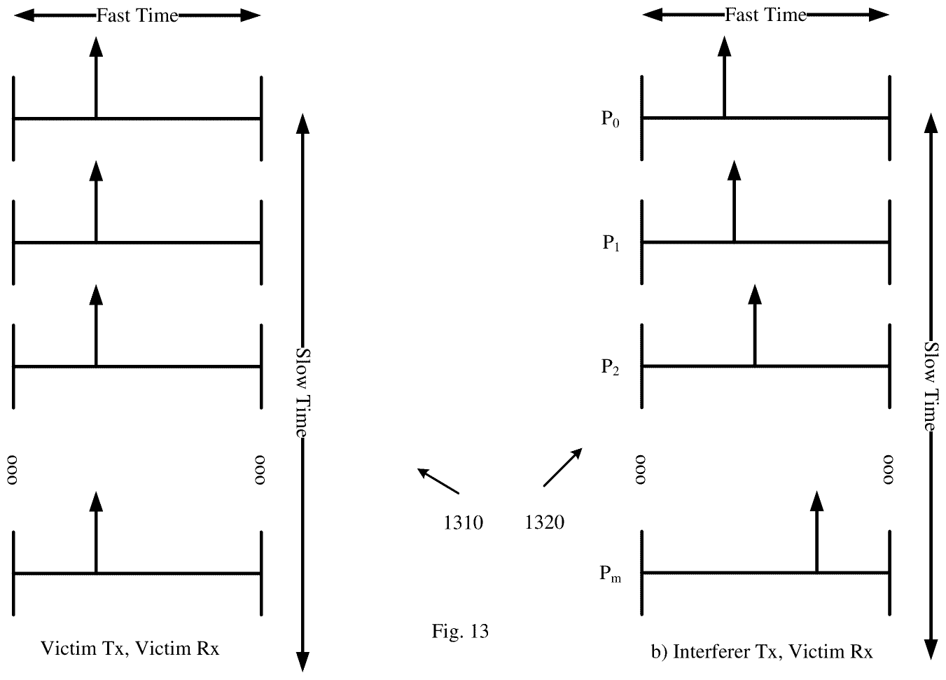

Reference is made to FIG. 13, which schematically illustrates a first slow time-fast time diagram 1310 and a second slow time-fast time diagram 1320, in accordance with some demonstrative aspects.

In some demonstrative aspects, as shown in FIG. 13, first slow time-fast time diagram 1310 may represent processing of an Rx signal including a plurality of Rx pulses, which may be received at a radar device, e.g., the victim device. For example, the Rx signal may be based on a Tx signal including a plurality of Tx pulses, which may be transmitted from the same radar device, e.g., the victim device.

In some demonstrative aspects, the Tx signal including the plurality of Tx pulses may be transmitted according to a particular PRI.

In some demonstrative aspects, as shown in FIG. 13, second slow time-fast time diagram 1320 may represent Rx processing of an interferer Rx signal including a plurality of interferer Rx pulses, which may be received at the radar device, e.g., the victim device. For example, the interferer Rx signal may be based on an interferer Tx signal including a plurality of interferer Tx pulses, which may be transmitted from an interferer radar device.

In some demonstrative aspects, the interferer Tx signal including the plurality of Tx pulses may be transmitted according to another PRI, which may be different from the particular PRI.

In some demonstrative aspects, as shown by first slow time-fast time diagram 1310, the plurality of Rx pulses, which are based on the Tx pulses transmitted by the victim radar device, may reside in a same range bin, which may allow accumulation of the Rx pulses for the same range bin. For example, the accumulation of the Rx pulses may result in a processing gain, e.g., a range processing gain.

In some demonstrative aspects, as shown by second slow time-fast time diagram 1320, the plurality of interferer Rx pulses may be smeared in the range domain, and may reside in a plurality of different range bins. For example, this range smearing of the plurality of interferer Rx pulses over the plurality of range bins may not allow accumulation of the interferer Rx pulses in the same range bin. For example, this range smearing of the plurality of interferer Rx pulses over the plurality of range bins may result in a reduced processing gain, e.g., which may be lower, e.g., much lower, than the processing gain for the Rx pulses, which are based on the Tx pulses transmitted by the victim radar device.

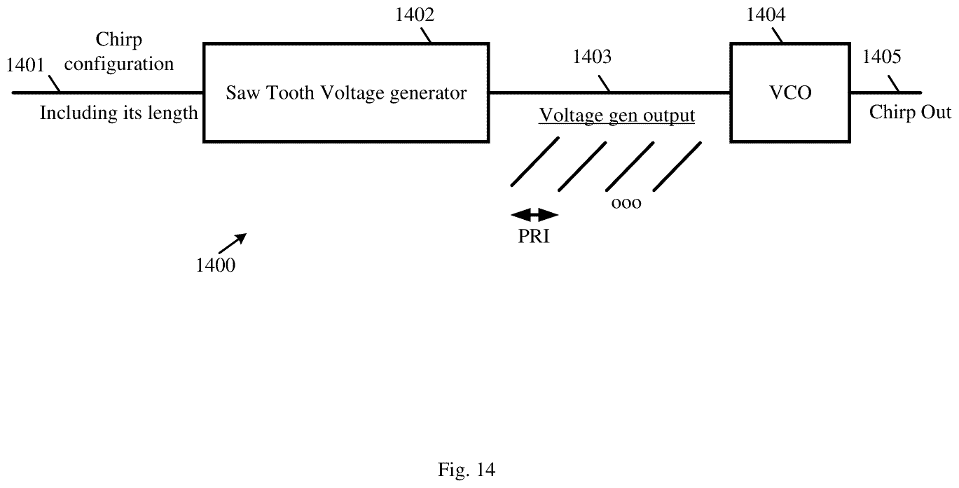

Reference is made to FIG. 14, which schematically illustrates a chirp generator 1400, in accordance with some demonstrative aspects.

For example, a radar device, e.g., radar device 1002 (FIG. 1), may implement one or more elements and/or functionalities of the chirp generator 1400 to generate one or more radar Tx pulses, e.g., radar Tx pulses 1015 (FIG. 1).

For example, as shown in FIG. 14, the chirp generator 1400 may be implemented as an analog chirp generator, which may be configured to support a PRI as a parameter for generating chirps.

In some demonstrative aspects, as shown in FIG. 14, chirp generator 1400 may include a saw tooth voltage generator 1402, which may be configured to generate a saw tooth voltage signal 1403. For example, the saw tooth voltage signal 1403 may be configured according to particular configuration for a pulse waveform.

In other aspects, the saw tooth voltage signal 1403 may be generated utilizing any other pulse generation mechanism.

In some demonstrative aspects, as shown in FIG. 14, chirp generator 1400 may include a VCO 1404, which may be configured to generate a plurality of chirps 1405, for example, based on the saw tooth voltage signal 1403.

In some demonstrative aspects, a processor, e.g., processor 1024 (FIG. 10), may be configured to generate Tx configuration information 1025 (FIG. 10) to configure transmission of the plurality of chirps 1405.

In some demonstrative aspects, the Tx configuration information 1025 (FIG. 10) may include the PRI as input 1401 to the chirp generator 1400.

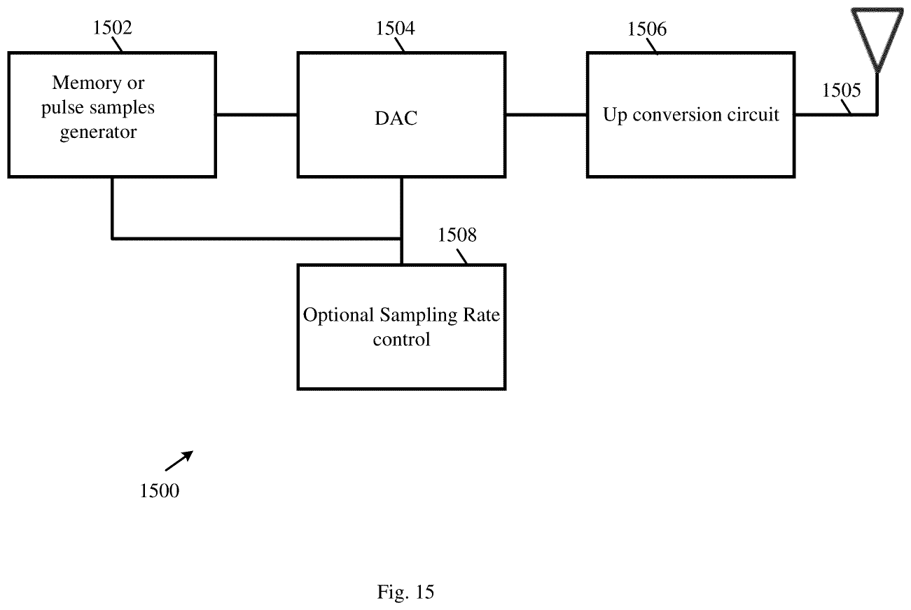

Reference is made to FIG. 15, which schematically illustrates a PRI configuration mechanism 1500, in accordance with some demonstrative aspects.

In some demonstrative aspects, as shown in FIG. 15, PRI configuration mechanism 1500 may include a memory 1502, which may be configured to store a pulse template.

In some demonstrative aspects, as shown in FIG. 15, PRI configuration mechanism 1500 may include a DAC 1504, which may be configured to convert the pulse template into an analog signal.

In some demonstrative aspects, as shown in FIG. 15, PRI configuration mechanism 1500 may include an up conversion circuit 1506, which may be configured to upconvert the analog signal for transmission as a plurality of pulses 1505.

In some demonstrative aspects, as shown in FIG. 15, PRI configuration mechanism 1500 may include a sampling rate controller 1508, which may be configured to control a sampling rate of the DAC 1504.

In some demonstrative aspects, PRI modification scheme 1500 may be configured to provide a technical solution to configure, set, modify, control, and/or change a PRI for a plurality of pulses 1505, e.g., the plurality of pulses 1015 (FIG. 10).

In some demonstrative aspects, as shown in FIG. 15, the PRI may be controlled, set, configured, modified, and/or changed, for example, by controlling, setting, configuring, modifying, and/or changing a length of a pulse template to be used for the generation of the plurality of pulses 1505. For example, the PRI may be controlled, set, configured, modified, and/or changed, for example, by controlling, setting, configuring, modifying, and/or changing a pulse template length, for example, e.g., in the memory 1502 that feeds the DAC 1504.

In some demonstrative aspects, as shown in FIG. 15, the PRI may be controlled, set, configured, modified, and/or changed, for example, by controlling, setting, configuring, modifying, and/or changing a PRI between the generated pulses in the pulse generation module.

In some demonstrative aspects, as shown in FIG. 15, the PRI may be controlled, set, configured, modified, and/or changed, for example, by controlling, setting, configuring, modifying, and/or changing a sampling clock of the DAC 1504.

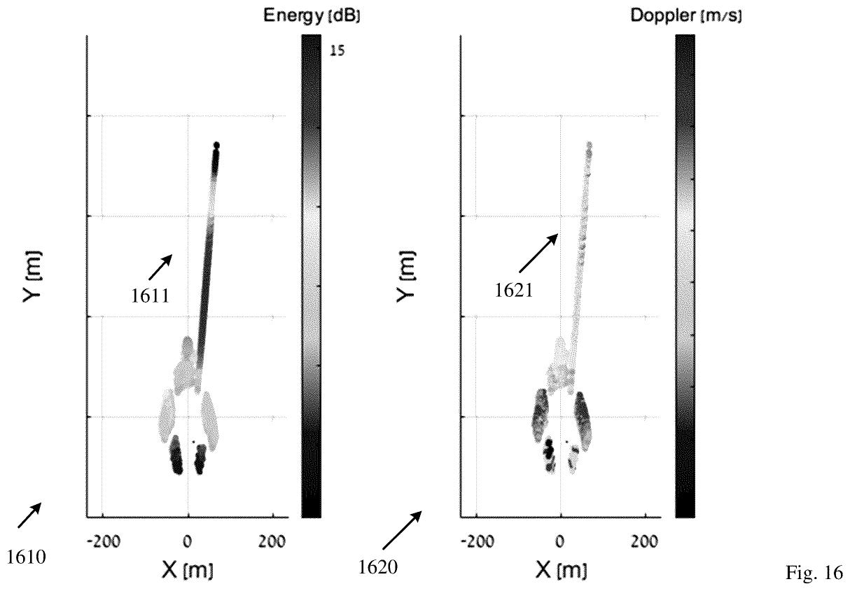

Reference is made to FIG. 16, which schematically illustrates simulation results to illustrate a range smearing effect, in accordance with some demonstrative aspects.

In some demonstrative aspects, as shown in FIG. 16, the simulation results may be represented in an energy domain and depicted in a range-energy graph 1610.

In some demonstrative aspects, as shown in FIG. 16, the simulation results may be represented in a doppler domain and depicted in a range-Doppler graph 1620.

In some demonstrative aspects, as shown in FIG. 16, the simulation result may illustrate a first range smearing effect 1611 in the energy domain.

In some demonstrative aspects, as shown in FIG. 16, radar Rx signals of an interferer radar may be smeared over a plurality of range bins in the range-energy graph 1610.

In some demonstrative aspects, as shown in FIG. 16, the simulation result may illustrate a second range smearing effect 1621 in the Doppler domain.

In some demonstrative aspects, as shown in FIG. 16, radar Rx signals of an interferer radar may be smeared over a plurality of range bins in the range-doppler graph 1620.

In one example, the range smearing effect may be based on a linear PRI change, which may be equivalent to +100 parts per million (ppm), e.g., a relative change of 1e-4.

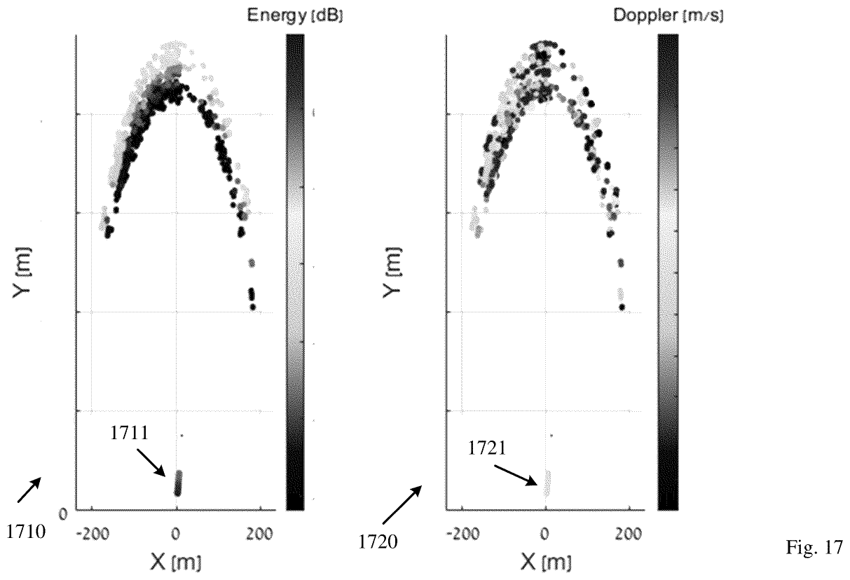

Reference is made to FIG. 17, which schematically illustrates simulation results to illustrate a range smearing effect, in accordance with some demonstrative aspects.

In some demonstrative aspects, as shown in FIG. 17, the simulation results may be represented in an energy domain and depicted in a range-energy graph 1710.

In some demonstrative aspects, as shown in FIG. 17, the simulation results may be represented in a doppler domain and depicted in a range-Doppler graph 1720.

In some demonstrative aspects, as shown in FIG. 17, the simulation result may illustrate a first range smearing effect 1711 in the energy domain.

In some demonstrative aspects, as shown in FIG. 17, radar Rx signals of an interferer radar may be smeared over a plurality of range bins in the range-energy graph 1710.

In some demonstrative aspects, as shown in FIG. 17, the simulation result may illustrate a second range smearing effect 1721 in the Doppler domain.

In some demonstrative aspects, as shown in FIG. 17, radar Rx signals of an interferer radar may be smeared over a plurality of range bins in range-doppler graph 1720.

In one example, the range smearing effect shown in FIG. 17 may result from “negative ranges”, e.g., resulting from a negative PRI difference, which may be impacted by Slow Time coding (STC) smearing.

For example, the simulation results of FIGS. 16 and 17 may illustrate the smearing effect as may be determined by two radar devices using different PRIs, for example, based on Rx signals received by each of the two radar devices.

In one example, the two radar devices may be co-located at a same vehicle.

In another example, the two radar devices may be located on two respective vehicles.

For example, the smearing effect shown in FIG. 16 may be determined by a first radar device using a first PRI, for example, based on “interferer” Rx signals received from a second radar device, which may be using, for example, a second PRI different from the first PRI. For example, the “positive” range smearing in FIG. 16 may result from a positive PRI difference between the first PRI and the second PRI.

For example, the smearing effect shown in FIG. 17 may be determined by the second radar device using the second PRI, for example, based on “interferer” Rx signals received from the second radar device, which may be using, for example, the first PRI. For example, the “negative” range smearing in FIG. 17 may result from a negative PRI difference between the second PRI and the first PRI.

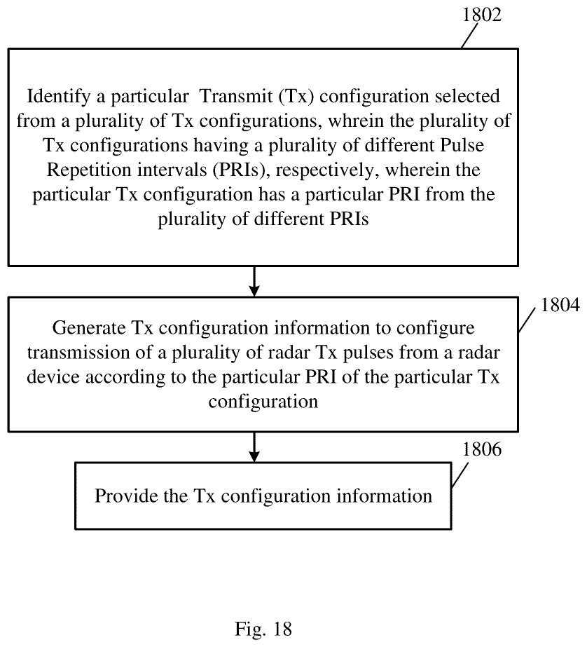

Reference is made to FIG. 18, which schematically illustrates a method of configuring transmission of a plurality of radar Tx pulses from a radar device, in accordance with some demonstrative aspects. For example, one or more of the operations of the method of FIG. 18 may be performed by a system, e.g., system 1001 (FIG. 10), radar system 900 (FIG. 9), and/or system 1101 (FIG. 11), a radar device, e.g., radar device 101 (FIG. 1), radar device 800 (FIG. 8), and/or radar device 910 (FIG. 9); a controller, e.g., controller 1020 (FIG. 10), and/or a processor, e.g., processor 1024 (FIG. 10).

As indicated at block 1802, the method may include identifying a particular Tx configuration selected from a plurality of Tx configurations. For example, the plurality of Tx configurations may have a plurality of different PRIs, respectively. For example, the particular Tx configuration may have a particular PRI from the plurality of different PRIs. For example, processor 1024 (FIG. 10) may be configured to identify the particular Tx configuration 1043 (FIG. 10) selected from the plurality of Tx configurations 1041 (FIG. 10), e.g., as described above.

As indicated at block 1804, the method may include generating Tx configuration information to configure transmission of a plurality of radar Tx pulses from a radar device according to the particular PRI of the particular Tx configuration. For example, processor 1024 (FIG. 10) may be configured to generate the Tx configuration information 1025 (FIG. 10) to configure the transmission of the plurality of radar Tx pulses 1015 (FIG. 10) from the radar device 1002 (FIG. 10), for example, according to the particular PRI 1045 (FIG. 10) of the particular Tx configuration 1043 (FIG. 10), e.g., as described above.

As indicated at block 1806, the method may include providing an output including the Tx configuration information. For example, processor 1024 (FIG. 11) may be configured to provide, e.g., via output 1026 (FIG. 11), the Tx configuration information 1025 (FIG. 10), e.g., as described above.

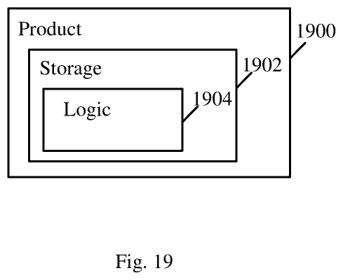

Reference is made to FIG. 19, which schematically illustrates a product of manufacture 1900, in accordance with some demonstrative aspects. Product 1900 may include one or more tangible computer-readable (“machine-readable”) non-transitory storage media 1902, which may include computer-executable instructions, e.g., implemented by logic 1904, operable to, when executed by at least one computer processor, enable the at least one computer processor to implement one or more operations and/or functionalities described with reference to any of the FIGS. 1-18, and/or one or more operations described herein. The phrases “non-transitory machine-readable medium” and “computer-readable non-transitory storage media” may be directed to include all machine and/or computer readable media, with the sole exception being a transitory propagating signal.

In some demonstrative aspects, product 1900 and/or machine-readable storage media 1902 may include one or more types of computer-readable storage media capable of storing data, including volatile memory, non-volatile memory, removable or non-removable memory, erasable or non-erasable memory, writeable or re-writeable memory, and the like. For example, machine-readable storage media 1902 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a disk, a hard drive, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 1904 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 1904 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, machine code, and the like.

### EXAMPLES

The following examples pertain to further aspects.

Example 1 includes an apparatus comprising a processor configured to identify a particular Transmit (Tx) configuration selected from a plurality of Tx configurations, the plurality of Tx configurations having a plurality of different Pulse Repetition Intervals (PRIs), respectively, wherein the particular Tx configuration has a particular PRI from the plurality of different PRIs; and generate Tx configuration information to configure transmission of a plurality of radar Tx pulses from a radar device according to the particular PRI of the particular Tx configuration; and an output to provide the Tx configuration information.

Example 2 includes the subject matter of Example 1, and optionally, wherein a PRI difference between first and second consecutive PRIs of the plurality of different PRIs is based on a range-bin duration corresponding to a range resolution based on the plurality of radar Tx pulses.

Example 3 includes the subject matter of Example 2, and optionally, wherein the PRI difference is based on the range-bin duration, and a predefined time-base variance value.

Example 4 includes the subject matter of any one of Examples 1-3, and optionally, wherein the plurality of different PRIs are configured based on a base PRI, a range-bin duration corresponding to a range resolution based on the plurality of radar Tx pulses, and a predefined time-base variance value.

Example 5 includes the subject matter of Example 4, and optionally, wherein the plurality of different PRIs comprises n different PRIs configured as follows:

$$PRI ( i ) = PRIbase + ai * offset + ai * bi * BINdur$$

wherein:
PRI(i) denotes an i-th PRI, i=1 . . . n,
PRIbase denotes the base PRI,
offset denotes the predefined time-base variance value,
BINdur denotes the range-bin duration,
ai denotes a first coefficient for the i-th PRI, wherein ai is 0, 1, or (−1),
bi denotes a second coefficient for the i-th PRI.

Example 6 includes the subject matter of any one of Examples 1-5, and optionally, wherein the plurality of different PRIs are configured according to a PRI coding scheme configured to provide a predefined range processing gain factor, the predefined range processing gain factor based on a ratio between a first range processing gain and a second range processing gain, the first range processing gain based on first radar Receive (Rx) signals received at the radar device based on the plurality of radar Tx pulses, the second range processing gain based on second radar Rx signals received at the radar device based on interferer Tx pulses from an interferer radar device.

Example 7 includes the subject matter of Example 6, and optionally, wherein the PRI coding scheme is configured such that the second radar Rx signals, when processed at the radar device, are to result in smeared range information, which is smeared over a plurality of range bins.

Example 8 includes the subject matter of Example 6 or 7, and optionally, wherein a PRI difference between first and second consecutive PRIs of the plurality of different PRIs is based on the predefined range processing gain factor.

Example 9 includes the subject matter of any one of Examples 6-8, and optionally, wherein the predefined range processing gain factor is based on a count of radar Tx pulses per radar frame.

Example 10 includes the subject matter of any one of Examples 6-9, and optionally, wherein the predefined range processing gain factor is based on a ratio between a count of radar Tx pulses per radar frame and a codebook factor, wherein the codebook factor is based on a ratio between a first PRI count and a second PRI count, the first PRI count comprises a count of the plurality of different PRIs, the second PRI count comprises a count of possible different PRIs when a PRI difference between each two consecutive PRIs of the possible different PRIs is equal to a range-bin duration.

Example 11 includes the subject matter of any one of Examples 6-10, and optionally, wherein the predefined range processing gain factor is equal to 10 log 10(N) decibel (dB), wherein N denotes a count of radar Tx pulses per radar frame, and wherein a PRI difference between first and second consecutive PRIs of the plurality of different PRIs is equal to a range-bin duration.

Example 12 includes the subject matter of any one of Examples 6-11, and optionally, wherein the predefined range processing gain factor is at least 10 decibel (dB).

Example 13 includes the subject matter of any one of Examples 1-12, and optionally, wherein the plurality of Tx configurations have a same Tx waveform setting.

Example 14 includes the subject matter of Example 13, and optionally, wherein the same Tx waveform setting comprises at least one of a same modulation setting, a same number-of-pulses-per-frame setting, a same slope setting, or a same frequency range setting.

Example 15 includes the subject matter of any one of Examples 1-14, and optionally, wherein the plurality of different PRIs are configured such that interferer radar Rx signals, when processed at the radar device based on the particular PRI, are to result in smeared range information, which is smeared over a plurality of range bins, the interferer radar Rx signals based on interferer Tx pulses according to another PRI different from the particular PRI.

Example 16 includes the subject matter of any one of Examples 1-15, and optionally, wherein the Tx configuration information is to configure a number of samples per radar Tx pulse to generate the plurality of radar Tx pulses based on the particular PRI of the particular Tx configuration.

Example 17 includes the subject matter of any one of Examples 1-16, and optionally, wherein the Tx configuration information is to configure a sampling rate to generate the plurality of radar Tx pulses based on the particular PRI of the particular Tx configuration.

Example 18 includes the subject matter of any one of Examples 1-17, and optionally, wherein the Tx configuration information is to configure a pulse length to generate the plurality of radar Tx pulses based on the particular PRI of the particular Tx configuration.

Example 19 includes the subject matter of any one of Examples 1-18, and optionally, wherein the processor is configured to generate first Tx configuration information to configure transmission of a first plurality of radar Tx pulses from the radar device according to a first particular PRI of a first particular Tx configuration selected from the plurality of Tx configurations, and to generate second Tx configuration information to configure transmission of a second plurality of radar Tx pulses from the radar device according to a second particular PRI of a second particular Tx configuration selected from the plurality of Tx configurations.

Example 20 includes the subject matter of Example 19, and optionally, wherein the first plurality of radar Tx pulses and the second plurality of radar Tx pulses are in a same radar frame.

Example 21 includes the subject matter of Example 20, and optionally, wherein the processor is configured to generate first frame Tx configuration information to configure transmission of a first radar frame, and second frame Tx configuration information to configure transmission of a second radar frame subsequent to the first radar frame, wherein the first frame Tx configuration information comprises the first Tx configuration information to configure transmission of the first plurality of radar Tx pulses followed by the second Tx configuration information to configure transmission of the second plurality of radar Tx pulses, wherein the second frame Tx configuration information comprises the first Tx configuration information to configure transmission of the first plurality of radar Tx pulses followed by the second Tx configuration information to configure transmission of the second plurality of radar Tx pulses.

Example 22 includes the subject matter of Example 20, and optionally, wherein the processor is configured to generate first frame Tx configuration information to configure transmission of a first radar frame, and second frame Tx configuration information to configure transmission of a second radar frame subsequent to the first radar frame, wherein the first frame Tx configuration information comprises the first Tx configuration information to configure transmission of the first plurality of radar Tx pulses followed by the second Tx configuration information to configure transmission of the second plurality of radar Tx pulses, wherein the second frame Tx configuration information comprises third Tx configuration information to configure transmission of a third plurality of radar Tx pulses according to a third particular PRI of a third particular Tx configuration selected from the plurality of Tx configurations, followed by fourth Tx configuration information to configure transmission of a fourth plurality of radar Tx pulses according to a fourth particular PRI of a fourth particular Tx configuration selected from the plurality of Tx configurations.

Example 23 includes the subject matter of Example 19, and optionally, wherein the first plurality of radar Tx pulses are in a first radar frame, and the second plurality of radar Tx pulses are in a second radar frame.

Example 24 includes the subject matter of Example 23, and optionally, wherein the processor is configured to generate first frame Tx configuration information to configure transmission of the first radar frame, and second frame Tx configuration information to configure transmission of the second radar frame subsequent to the first radar frame, wherein the first frame Tx configuration information comprises the first Tx configuration information to configure transmission of the first plurality of radar Tx pulses, wherein the second frame Tx configuration information comprises the second Tx configuration information to configure transmission of the second plurality of radar Tx pulses.

Example 25 includes the subject matter of any one of Examples 1-24, and optionally, wherein the processor is configured to determine a plurality of particular Tx configurations to be simultaneously implemented by a plurality of radar devices co-located in a vehicle, the plurality of particular Tx configurations comprising a first Tx configuration and a second Tx configuration selected from the plurality of Tx configurations, the first Tx configuration having a first PRI, the second Tx configuration having a second PRI different from the first PRI.

Example 26 includes the subject matter of any one of Examples 1-25, and optionally, wherein the processor is configured to process input information to identify the particular Tx configuration selected from the plurality of Tx configurations.

Example 27 includes the subject matter of any one of Examples 1-25, and optionally, wherein the processor is configured to select the particular Tx configuration from the plurality of Tx configurations based on a predefined criterion.

Example 28 includes the subject matter of Example 27, and optionally, wherein the predefined criterion is configured for detection of interferer radar Rx signals received at the radar device from an interferer radar device.

Example 29 includes the subject matter of any one of Examples 1-25, and optionally, wherein the processor is configured to randomly select the particular Tx configuration from the plurality of Tx configurations.

Example 30 includes the subject matter of any one of Examples 1-29, and optionally, wherein a PRI difference between first and second consecutive PRIs of the plurality of different PRIs is equal to or longer than 5 percent of a range-bin duration corresponding to a range resolution based on the plurality of radar Tx pulses.

Example 31 includes the subject matter of any one of Examples 1-30, and optionally, wherein a PRI difference between first and second consecutive PRIs of the plurality of different PRIs is equal to or longer than 10 percent of a range-bin duration corresponding to a range resolution based on the plurality of radar Tx pulses.

Example 32 includes the subject matter of any one of Examples 1-31, and optionally, wherein a PRI difference between first and second consecutive PRIs of the plurality of different PRIs is equal to or longer than 25 percent of a range-bin duration corresponding to a range resolution based on the plurality of radar Tx pulses.

Example 33 includes the subject matter of any one of Examples 1-32, and optionally, wherein a PRI difference between first and second consecutive PRIs of the plurality of different PRIs is equal to or longer than 50 percent of a range-bin duration corresponding to a range resolution based on the plurality of radar Tx pulses.

Example 34 includes the subject matter of any one of Examples 1-33, and optionally, wherein a PRI difference between first and second consecutive PRIs of the plurality of different PRIs is equal to or longer than a range-bin duration corresponding to a range resolution based on the plurality of radar Tx pulses.

Example 35 includes the subject matter of any one of Examples 1-34, and optionally, wherein a PRI difference between first and second consecutive PRIs of the plurality of different PRIs is equal to or longer than 1/10,000 of each of the first and second consecutive PRIs.

Example 36 includes the subject matter of any one of Examples 1-35, and optionally, wherein a PRI difference between first and second consecutive PRIs of the plurality of different PRIs is shorter than ten times a range-bin duration corresponding to a range resolution based on the plurality of radar Tx pulses.

Example 37 includes the subject matter of any one of Examples 1-36, and optionally, wherein a PRI difference between first and second consecutive PRIs of the plurality of different PRIs is shorter than five times a range-bin duration corresponding to a range resolution based on the plurality of radar Tx pulses.

Example 38 includes the subject matter of any one of Examples 1-37, and optionally, wherein a PRI difference between first and second consecutive PRIs of the plurality of different PRIs is shorter than a duration of 10 samples according to a sampling rate to generate the plurality of radar Tx pulses.

Example 39 includes the subject matter of any one of Examples 1-38, and optionally, wherein a PRI difference between first and second consecutive PRIs of the plurality of different PRIs is shorter than a duration of 5 samples according to a sampling rate to generate the plurality of radar Tx pulses.

Example 40 includes the subject matter of any one of Examples 1-39, and optionally, wherein a PRI difference between first and second consecutive PRIs of the plurality of different PRIs is equal to or longer than a duration of 1 sample according to a sampling rate to generate the plurality of radar Tx pulses.

Example 41 includes the subject matter of any one of Examples 1-40, and optionally, comprising the radar device, the radar device comprising a transmitter to transmit the plurality of radar Tx pulses, a receiver to receive a plurality of radar receive (Rx) signals based on the plurality of radar Tx pulses, and a radar processor to determine radar information based on the plurality of radar Rx signals.

Example 42 includes the subject matter of Example 41, and optionally, comprising a vehicle, the vehicle comprising the radar device, and a system controller to control one or more systems of the vehicle based on the radar information.

Example 43 includes a radar device comprising the subject matter of any of Examples 1-41.

Example 44 includes a vehicle comprising the subject matter of any of Examples 1-41.

Example 45 includes an apparatus comprising means for performing any of the described operations of any of Examples 1-41.

Example 46 includes a machine-readable medium that stores instructions for execution by a processor to perform any of the described operations of any of Examples 1-41.

Example 47 comprises a product comprising one or more tangible computer-readable non-transitory storage media comprising instructions operable to, when executed by at least one processor, enable the at least one processor to cause a device and/or system to perform any of the described operations of any of Examples 1-41.

Example 48 includes an apparatus comprising a memory; and processing circuitry configured to perform any of the described operations of any of Examples 1-41.

Example 48 includes a method including any of the described operations of any of Examples 1-41.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. An apparatus comprising:
a processor configured to:
identify a particular Transmit (Tx) configuration selected from a plurality of Tx configurations, the plurality of Tx configurations having a plurality of different Pulse Repetition Intervals (PRIs), respectively, wherein the particular Tx configuration has a particular PRI from the plurality of different PRIs; and
generate Tx configuration information to configure transmission of a plurality of radar Tx pulses from a radar device according to the particular PRI of the particular Tx configuration; and
an output to provide the Tx configuration information.

2. The apparatus of claim 1, wherein a PRI difference between first and second consecutive PRIs of the plurality of different PRIs is based on a range-bin duration corresponding to a range resolution based on the plurality of radar Tx pulses.

3. The apparatus of claim 1, wherein the plurality of different PRIs are configured based on a base PRI, a range-bin duration corresponding to a range resolution based on the plurality of radar Tx pulses, and a predefined time-base variance value.

4. The apparatus of claim 3, wherein the plurality of different PRIs comprises n different PRIs configured as follows:
$$PRI ( i ) = PRIbase + ai * offset + ai * bi * BINdur$$
wherein:
PRI(i) denotes an i-th PRI, i=1 . . . n,
PRIbase denotes the base PRI,
offset denotes the predefined time-base variance value,
BINdur denotes the range-bin duration,
ai denotes a first coefficient for the i-th PRI, wherein ai is 0, 1, or (−1),
bi denotes a second coefficient for the i-th PRI.

5. The apparatus of claim 1, wherein the plurality of different PRIs are configured according to a PRI coding scheme configured to provide a predefined range processing gain factor, the predefined range processing gain factor based on a ratio between a first range processing gain and a second range processing gain, the first range processing gain based on first radar Receive (Rx) signals received at the radar device based on the plurality of radar Tx pulses, the second range processing gain based on second radar Rx signals received at the radar device based on interferer Tx pulses from an interferer radar device.

6. The apparatus of claim 5, wherein the PRI coding scheme is configured such that the second radar Rx signals, when processed at the radar device, are to result in smeared range information, which is smeared over a plurality of range bins.

7. The apparatus of claim 5, wherein a PRI difference between first and second consecutive PRIs of the plurality of different PRIs is based on the predefined range processing gain factor.

8. The apparatus of claim 5, wherein the predefined range processing gain factor is based on a ratio between a count of radar Tx pulses per radar frame and a codebook factor, wherein the codebook factor is based on a ratio between a first PRI count and a second PRI count, the first PRI count comprises a count of the plurality of different PRIs, the second PRI count comprises a count of possible different PRIs when a PRI difference between each two consecutive PRIs of the possible different PRIs is equal to a range-bin duration.

9. The apparatus of claim 5, wherein the predefined range processing gain factor is equal to 10 log 10(N) decibel (dB), wherein N denotes a count of radar Tx pulses per radar frame, and wherein a PRI difference between first and second consecutive PRIs of the plurality of different PRIs is equal to a range-bin duration.

10. The apparatus of claim 5, wherein the predefined range processing gain factor is at least 10 decibel (dB).

11. The apparatus of claim 1, wherein the plurality of Tx configurations have at least one of a same modulation setting, a same number-of-pulses-per-frame setting, a same slope setting, or a same frequency range setting.

12. The apparatus of claim 1, wherein the plurality of different PRIs are configured such that interferer radar Rx signals, when processed at the radar device based on the particular PRI, are to result in smeared range information, which is smeared over a plurality of range bins, the interferer radar Rx signals based on interferer Tx pulses according to another PRI different from the particular PRI.

13. The apparatus of claim 1, wherein the Tx configuration information is to configure at least one of a number of samples per radar Tx pulse to generate the plurality of radar Tx pulses based on the particular PRI of the particular Tx configuration, a sampling rate to generate the plurality of radar Tx pulses based on the particular PRI of the particular Tx configuration, or a pulse length to generate the plurality of radar Tx pulses based on the particular PRI of the particular Tx configuration.

14. The apparatus of claim 1, wherein the processor is configured to generate first Tx configuration information to configure transmission of a first plurality of radar Tx pulses from the radar device according to a first particular PRI of a first particular Tx configuration selected from the plurality of Tx configurations, and to generate second Tx configuration information to configure transmission of a second plurality of radar Tx pulses from the radar device according to a second particular PRI of a second particular Tx configuration selected from the plurality of Tx configurations.

15. The apparatus of claim 14, wherein the first plurality of radar Tx pulses and the second plurality of radar Tx pulses are in a same radar frame.

16. The apparatus of claim 15, wherein the processor is configured to generate first frame Tx configuration information to configure transmission of a first radar frame, and second frame Tx configuration information to configure transmission of a second radar frame subsequent to the first radar frame, wherein the first frame Tx configuration information comprises the first Tx configuration information to configure transmission of the first plurality of radar Tx pulses followed by the second Tx configuration information to configure transmission of the second plurality of radar Tx pulses, wherein the second frame Tx configuration information comprises the first Tx configuration information to configure transmission of the first plurality of radar Tx pulses followed by the second Tx configuration information to configure transmission of the second plurality of radar Tx pulses.

17. The apparatus of claim 1, wherein the processor is configured to determine a plurality of particular Tx configurations to be simultaneously implemented by a plurality of radar devices co-located in a vehicle, the plurality of particular Tx configurations comprising a first Tx configuration and a second Tx configuration selected from the plurality of Tx configurations, the first Tx configuration having a first PRI, the second Tx configuration having a second PRI different from the first PRI.

18. The apparatus of claim 1, wherein a PRI difference between first and second consecutive PRIs of the plurality of different PRIs is equal to or longer than 5 percent of a range-bin duration corresponding to a range resolution based on the plurality of radar Tx pulses.

19. The apparatus of claim 1, wherein a PRI difference between first and second consecutive PRIs of the plurality of different PRIs is equal to or longer than 1/10,000 of each of the first and second consecutive PRIs.

20. The apparatus of claim 1, wherein a PRI difference between first and second consecutive PRIs of the plurality of different PRIs is shorter than ten times a range-bin duration corresponding to a range resolution based on the plurality of radar Tx pulses.

21. The apparatus of claim 1, wherein a PRI difference between first and second consecutive PRIs of the plurality of different PRIs is shorter than a duration of 10 samples according to a sampling rate to generate the plurality of radar Tx pulses.

22. The apparatus of claim 1 comprising the radar device, the radar device comprising a transmitter to transmit the plurality of radar Tx pulses, a receiver to receive a plurality of radar receive (Rx) signals based on the plurality of radar Tx pulses, and a radar processor to determine radar information based on the plurality of radar Rx signals.

23. A product comprising one or more tangible computer-readable non-transitory storage media comprising instructions operable to, when executed by at least one processor, enable the at least one processor to:
identify a particular Transmit (Tx) configuration selected from a plurality of Tx configurations, the plurality of Tx configurations having a plurality of different Pulse Repetition Intervals (PRIs), respectively, wherein the particular Tx configuration has a particular PRI from the plurality of different PRIs;
generate Tx configuration information to configure transmission of a plurality of radar Tx pulses from a radar device according to the particular PRI of the particular Tx configuration.

24. The product of claim 23, wherein the Tx configuration information is to configure at least one of a number of samples per radar Tx pulse to generate the plurality of radar Tx pulses based on the particular PRI of the particular Tx configuration, a sampling rate to generate the plurality of radar Tx pulses based on the particular PRI of the particular Tx configuration, or a pulse length to generate the plurality of radar Tx pulses based on the particular PRI of the particular Tx configuration.
